(19) United States
(12) Patent Application Publication
(10) Pub. No.: US 2004/0053177 A1
(43) Pub. Date: Mar. 18, 2004

(54) Silver salt photothermographic dry imaging material

(75) Inventors: Hiroshi Kashiwagi, Tokyo (JP); Hideki Takiguchi, Sagamihara (JP); Soc Man Ho Kimura, Tokyo (JP)

Correspondence Address: Muserlian, Lucas and Mercanti, 600 Third Avenue, New York, NY, 10016, US

(73) Assignee: Konica Corporation, Tokyo (JP)

(21) Appl. No.: 10/657,661

(22) Filed: Sep. 8, 2003

(30) Foreign Application Priority Data
Sep. 13, 2002 (JP) JP2002-268119

(51) Int. Cl. G03C 1/498; G03C 1/09

(52) U.S. Cl. 430/619; 430/604; 430/605; 430/620

(57) ABSTRACT

A photothermographic material is disclosed, comprising a light-insensitive silver salt of an aliphatic carboxylic acid and light-sensitive silver halide grains, a reducing agent for silver ions and a binder, wherein the photothermographic material further comprises a compound represented by the following formula, and the photothermographic material meets the following requirement:

S_{B}/S_{A}≦0.2

wherein S_{A} represents a sensitivity obtained when exposed and thermally developed, and S_{B} represents a sensitivity obtained when subjected to a heat treatment at 110° C. for 15 sec., then, exposed and thermally developed

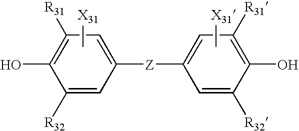

### FIELD OF THE INVENTION

The present invention relates to silver salt photothermographic dry imaging material, and an image recording method and image forming method by use thereof.

### BACKGROUND OF THE INVENTION

In the field of medical diagnosis and graphic arts, there have been concerns in processing of photographic film with respect to effluent produced from wet-processing of image forming materials, and recently, reduction of the processing effluent is strongly demanded in terms of environmental protection and space saving.

Accordingly, there has been desired techniques relating to a photothermographic material in which efficient light-exposure is feasible as is done in a laser imager or laser image setter and by which definite, clear black images are obtained.

There have been known a silver salt photothermographic dry imaging material comprising on a support an organic silver salt, light-sensitive silver halide and a reducing agent, as described in U.S. Pat. Nos. 3,152,904 and 3,487,075, and D. Morgan, “Dry Silver Photographic Materials” (Handbook of Imaging Materials, Marcel Dekker, Inc. page 48, 1991). This photothermographic material advantageously renders possible formation of distinct black images exhibiting high sharpness, enabling efficient exposure by means of a laser imager or a laser image setter. Thus, in the photothermographic material, in the light-sensitive layer, light-sensitive silver halide and organic silver salt function as a photosensor and silver source, respectively, which are thermally developed at a temperature of 80 to 250° C. with the reducing agent to form images, without being further subjected to fixing.

However, Containing such an organic silver salt, light-sensitive silver halide together with a reducing agent often causes fogging during storage prior to thermal development. Furthermore, since the photothermographic material is simply thermally developed at 80 to 250° C., without being fixed, all or a part of the silver halide, organic salt and reducing agent remain, leading to thermal or photolytic formation of metallic silver during a long period of storage and producing problems that image quality such as silver image tone easily varies. There were disclosed techniques to overcome such problems, as described in JP-A Nos. 208192, 8-267934, and 200-16661 (hereinafter, the term, JP-A refers to Japanese Patent Application Publication), U.S. Pat. No. 5,714,311 and European Patent No. 1,096,310. However, the disclosed techniques resulted in a certain extent of effect, which was still insufficient to meet the level desired in the market.

There were further proved problems that for the purpose of enhancing silver covering power, decreasing the grain size of light-sensitive silver halide contained in the photothermographic material and increasing the of the grains resulted in marked variation or deterioration in image quality such as silver image tone, due to influence of light received by light-sensitive silver halide grains during storage or at the time of observation.

Specifically, enhanced image quality to render accurate diagnosis feasible has desired as one of essential characteristics in photothermographic material for use in medical diagnosis. For instance, silver image tone that hardly causes eyestrain has been desired. To achieve such silver image tone, there was proposed a technique for controlling the shape or size of developed silver by using a reducing agent for silver ions or a toning agent, as described in JP-A No. 2000-209144. There was also the combined use of a specific reducing agent for silver ions and a specific p-bisphenol compound, as described in JP-A No. 2002-169249. However, it was proved that image qualities attained by the foregoing techniques were not a satisfactory level. There were defects such that improving image tone to a level acceptable in the market often caused fogging or variation in tone before or after image formation.

### SUMMARY OF THE INVENTION

In light of the foregoing, the present invention has been made. Thus, it is an object of the invention to provide silver salt photothermographic materials exhibiting superior storage stability and silver image lasting quality as well as enhanced sensitivity and minimized fogging, and an image recording method and image forming method by the use of the same.

The foregoing object of the invention can be accomplished by the following constitution:

1. A silver salt photothermographic dry imaging material comprising on a support a light-sensitive layer containing a light-insensitive silver salt of a aliphatic carboxylic carboxylic acid and light-sensitive silver halide grains, a reducing agent for silver ions and a binder, wherein the photothermographic material further comprises a compound represented by the following formula (1), and the photothermographic material meets the following requirement:

S_{B}/S_{A}≦0.2

wherein S_{A} represents a sensitivity of the photothermographic material obtained when exposed and thermally developed, and S_{B} represents a sensitivity of the photothermographic material obtained when subjected to a heat treatment, followed by being exposed and thermally developed;

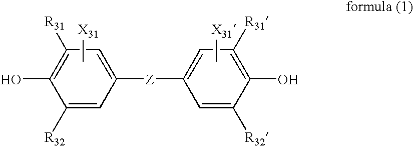

wherein Z is —S— or —C(R₃₃) (R₃₃′)—, in which R₃₃ and R₃₃′ are each a hydrogen atom or a substituent; R₃₁, R₃₂, R₃₁′ and R₃₂ ′ are each a substituent; X₃₁ and X₃₁′ are each a hydrogen atom or a substituent.

### DETAILED DESCRIPTION OF THE INVENTION

In one aspect of the invention, the silver salt photothermographic dry imaging material (hereinafter, also denoted simply as photothermographic material) contains bisphenol compounds represented by the foregoing formula (1), as an image tone control agent.

In the formula (1), Z represents —S— or —C(R₃₃) (R₃₃′)—, in which R₃₃ and R₃₃′ each represents a hydrogen atom or a substituent. Examples of the substituent represented by R₃₃ and R₃₃′ include an alkyl group (e.g., methyl, ethyl, propyl, isopropyl, butyl, isobutyl, sec-butyl, t-butyl), cycloalkyl group (e.g., cyclopropyl, cyclohexyl, 1-methyl-cyclohexyl), alkenyl group (e.g., vinyl, propenyl, butenyl, pentenyl, isohexenyl, butenylidene, isopentylidene), cycloalkenyl group (e.g., e.g., cyclohexenyl), alkynyl group (e.g., ethynyl, propynylidene), aryl group (e.g., phenyl, naphthyl), heterocyclic group (e.g., furyl, thienyl, pyridyl, tetrahydrofuranyl), halogen atom, hydroxyl, alkoxy group, aryloxy group, acyloxy group, sulfonyloxy group, nitro, amino group, acylamino group, sulfonylamino group, sulfonyl group, carboxy group, alkoxycarbonyl group, aryloxycarbonyl group, carbamoyl group, sulfamoyl group, cyano and sulfo. Of these, R₃₃ and R₃₃′ are each preferably a hydrogen atom, or an alkyl or cycloalkyl group, and it is more preferred that at least one of R₃₃ and R₃₃′ is a hydrogen atom and the other one is a hydrogen atom or an alkyl or cycloalkyl group.

R₃₁, R₃₂, R₃₁′ and R₃₂′ each represents a substituent. Substituents represented by R₃₁, R₃₂, R₃₁′ and R₃₂′ are the same as those described above for R₃₃ and R₃₃′. R₃₁, R₃₂, R₃₁′ and R₃₂′ are each preferably an alkyl group, alkenyl group, alkynyl group, cycloalkyl group, cycloalkenyl group, aryl group or heterocyclic group, and more preferably an alkyl or cycloalkyl group. The alkyl or cycloalkyl group may be substituted and substituents thereof are the same as described in R₃₃ and R₃₃′. It is still more preferred that at least one (preferably at least two) of R₃₁, R₃₂, R₃₁′ and R₃₂′ is a tertiary alkyl or cycloalkyl group, such as t-butyl, t-amyl, t-octyl or 1-methylcyclohexyl.

X₃₁ and X₃₁′ each represents a hydrogen atom or a substituent. The substituent is the same as described in R₃₃ and R₃₃′.

Specific examples of the bisphenol compound represented by formula (1) are shown below but by no means limited to these.

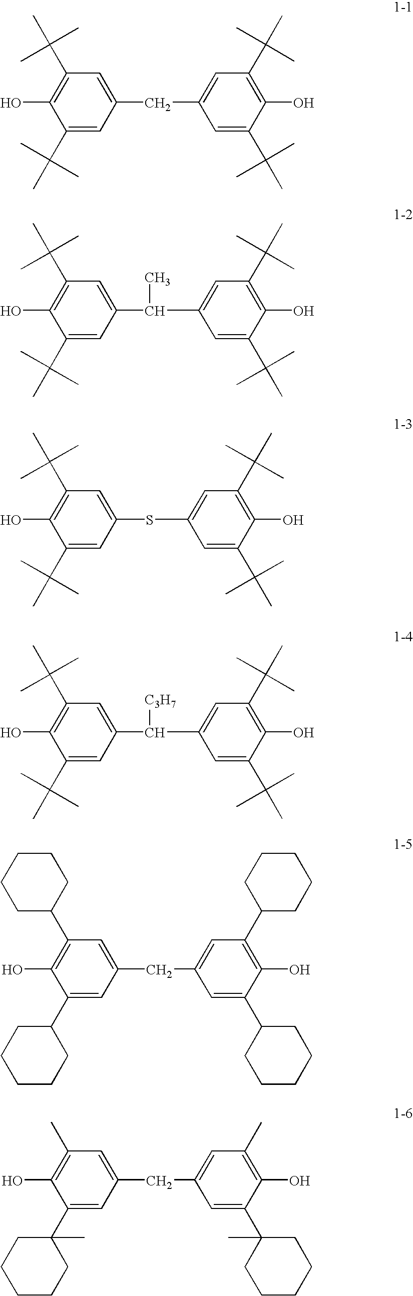

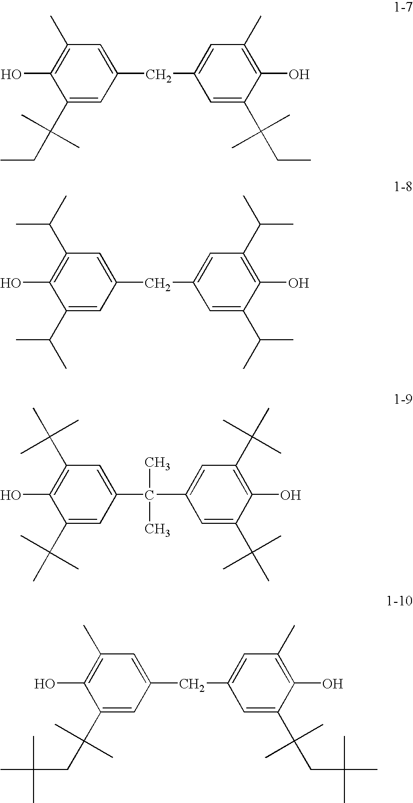

The compounds represented by the formula (A-1) or (A-2) are dispersed in water or dissolved in an organic solvent, and incorporated into a coating solution for the light-sensitive layer or a layer adjacent to the light-sensitive layer. The organic solvent can optionally be selected from alcohols such as methanol and ethanol, ketones such as acetone and methyl ethyl ketone and aromatic solvents such as toluene and xylene.

The compound represented by the formula (A-2) is used preferably in an amount of 1×10⁻² to 10 mol, and more preferably 1×10⁻² to 1.5 mol per mol of silver.

Light-sensitive silver halide grains used in this invention are those which are capable of absorbing light as an inherent property of silver halide crystal or capable of absorbing visible or infrared light by artificial physico-chemical methods, and which are treated or prepared so as to cause a physico-chemical change in the interior and/or on the surface of the silver halide crystal upon absorbing light within the region of ultraviolet to infrared.

The silver halide grains used in the invention can be prepared according to the methods described in P. Glafkides, Chimie Physique Photographique (published by Paul Montel Corp., 19679; G. F. Duffin, Photographic Emulsion Chemistry (published by Focal Press, 1966); V. L. Zelikman et al., Making and Coating of Photographic Emulsion (published by Focal Press, 1964). Any one of acidic precipitation, neutral precipitation and ammoniacal precipitation is applicable and the reaction mode of aqueous soluble silver salt and halide salt includes single jet addition, double jet addition and a combination thereof. Specifically, preparation of silver halide grains with controlling the grain formation condition, so-called controlled double-jet precipitation is preferred. The halide composition of silver halide is not specifically limited and may be any one of silver chloride, silver chlorobromide, silver iodochlorobromide, silver bromide, silver iodobromide and silver iodide. Specifically, silver bromide or silver iodobromide is preferred. In the case of silver iodobromide, the iodide content thereof is preferably 0.02 to 6 mol %/Ag mol. The iodide may be distributed overall within grain or localized in a specific portion of the grain, such as a core/shell structure comprising the central portion containing a relatively high iodide and surface portion containing a relatively low or substantially no iodide.

The grain forming process is usually classified into two stages of formation of silver halide seed crystal grains (nucleation) and grain growth. These stages may continuously be conducted, or the nucleation (seed grain formation) and grain growth may be separately performed. The controlled double-jet precipitation, in which grain formation is undergone with controlling grain forming conditions such as pAg and pH, is preferred to control the grain form or grain size. In cases when nucleation and grain growth are separately conducted, for example, a soluble silver salt and a soluble halide salt are homogeneously and promptly mixed in an aqueous gelatin solution to form nucleus grains (seed grains), thereafter, grain growth is performed by supplying soluble silver and halide salts, while being controlled at a pAg and pH to prepare silver halide grains.

In order to minimize cloudiness or yellowish coloring oof images after image formation and to obtain excellent image quality, the less the average grain size, the more preferred. Silver halide grains having a grain size of 0.04 to 0.07 μm preferably accounts for at least 50% by weight of total silver halide grains, based on silver. Thus, it is preferred that silver halide grain having a grain size of less than 0.04 μm and silver halide grains having a grain size of more than 0.07 μm account for less than 50% by weight, based on silver. When silver halide grains having an average grain size of less than 0.02 μm are regarded as being non-target for measurement, the total amount of silver halide grains of 0.02 to 0.04 μm and grains of 0.07 to 0.20 μm preferably accounts for less than 50% (more preferably less than 40%) of total silver halide grains, based on silver. The use of silver halide grains having the foregoing grain size distribution results in improved image lasting quality. It is contemplated that the use of silver halide grains having a relatively high proportion of larger grain sizes easily form print-out silver or silver images, due to high sensitivity of the grains when used on a viewing box using a fluorescent lamp for a short period of time or at a relatively low luminance. It is also contemplated that silver halide grains of smaller grain sizes, which are relatively low light-sensitive, result in an increased in the number of developed silver points due to large number of grains, when placed on the viewing box, leading to an increased optical density. In addition to the foregoing, the preferred grain size ranges of this invention to achieve an intended characteristic curve include the case where silver halide grains of 0.02 to 0.04 μm and 0.07 to 0.20 μm are not substantially contained.

The grain size as described above is defined as an average edge length of silver halide grains, in cases where they are so-called regular crystals in the form of cube or octahedron. Furthermore, in cases where grains are tabular grains, the grain size refers to the diameter of a circle having the same area as the projected area of the major faces. Furthermore, silver halide grains are preferably monodisperse grains.

The monodisperse grains as described herein refer to grains having a coefficient of variation of grain size obtained by the formula described below of not more than 30%; more preferably not more than 20%, and still more preferably not more than 15%:

Coefficient of variation of grain size=standard deviation of grain diameter/average grain diameter×100 (%)

The grain form can be of almost any one, including cubic, octahedral or tetradecahedral grains, tabular grains, spherical grains, bar-like grains, and potato-shaped grains. Of these, cubic grains, octahedral grains, tetradecahedral grains and tabular grains are specifically preferred.

The aspect ratio of tabular grains is preferably 1.5 to 100, and more preferably 2 to 50. These grains are described in U.S. Pat. Nos. 5,264,337, 5,314,798 and 5,320,958 and desired tabular grains can be readily obtained. Silver halide grains having rounded corners are also preferably employed.

Crystal habit of the outer surface of the silver halide grains is not specifically limited, but in cases when using a spectral sensitizing dye exhibiting crystal habit (face) selectivity in the adsorption reaction of the sensitizing dye onto the silver halide grain surface, it is preferred to use silver halide grains having a relatively high proportion of the crystal habit meeting the selectivity. In cases when using a sensitizing dye selectively adsorbing onto the crystal face of a Miller index of [100], for example, a high ratio accounted for by a Miller index [100] face is preferred. This ratio is preferably at least 50%; is more preferably at least 70%, and is most preferably at least 80%. The ratio accounted for by the Miller index [100] face can be obtained based on T. Tani, J. Imaging Sci., 29, 165 (1985) in which adsorption dependency of a [111] face or a [100] face is utilized.

It is preferred to use low molecular gelatin having an average molecular weight of not more than 50,000 in the preparation of silver halide grains used in the invention, specifically, in the stage of nucleation. Thus, the low molecular gelatin has an average molecular eight of not more than 50,000, preferably 2,000 to 40,000, and more preferably 5,000 to 25,000. The average molecular weight can be determined by means of gel permeation chromatography.

The concentration of dispersion medium used in the nucleation stage is preferably not more than 5% by weight, and more preferably 0.05 to 3.0% by weight.

In the preparation of silver halide grains, it is preferred to use a compound represent by the following formula, specifically in the nucleation stage:

YO(CH₂CH₂O)m(C(CH₃) CH₂O)p(CH₂CH₂O)ₙY

where Y is a hydrogen atom, —SO₃M or —CO—B—COOM, in which M is a hydrogen atom, alkali metal atom, ammonium group or ammonium group substituted by an alkyl group having carbon atoms of not more than 5, and B is a chained or cyclic group forming an organic dibasic acid; m and n each are 0 to 50; and p is 1 to 100. Polyethylene oxide compounds represented by foregoing formula have been employed as a defoaming agent to inhibit marked foaming occurred when stirring or moving emulsion raw materials, specifically in the stage of preparing an aqueous gelatin solution, adding a water-soluble silver and halide salts to the aqueous gelatin solution or coating an emulsion on a support during the process of preparing silver halide photographic light sensitive materials. A technique of using these compounds as a defoaming agent is described in JP-A No. 44-9497. The polyethylene oxide compound represented by the foregoing formula also functions as a defoaming agent during nucleation. The compound represented by the foregoing formula is used preferably in an amount of not more than 1%, and more preferably 0.01 to 0.1% by weight, based on silver.

The compound is to be present at the stage of nucleation, and may be added to a dispersing medium prior to or during nucleation. Alternatively, the compound may be added to an aqueous silver salt solution or halide solution used for nucleation. It is preferred to add it to a halide solution or both silver salt and halide solutions in an amount of 0.01 to 2.0% by weight. It is also preferred to make the compound represented by formula [5] present over a period of at least 50% (more preferably, at least 70%) of the nucleation stage.

The temperature during the stage of nucleation is preferably 5 to 60° C., and more preferably 15 to 50° C. Even when nucleation is conducted at a constant temperature, in a temperature-increasing pattern (e.g., in such a manner that nucleation starts at 25° C. and the temperature is gradually increased to reach 40° C. at the time of completion of nucleation) or its reverse pattern, it is preferred to control the temperature within the range described above.

Silver salt and halide salt solutions used for nucleation are preferably in a concentration of not more than 3.5 mol/l, and more preferably 0.01 to 2.5 mol/l. The flow rate of aqueous silver salt solution is preferably 1.5×10⁻³ to 3.0×10⁻¹ mol/min per liter of the solution, and more preferably 3.0×10⁻³ to 8.0×10⁻² mol/min. per liter of the solution. The pH during nucleation is within a range of 1.7 to 10, and since the pH at the alkaline side broadens the grain size distribution, the pH is preferably 2 to 6. The pBr during nucleation is 0.05 to 3.0, preferably 1.0 to 2.5, and more preferably 1.5 to 2.0.

In one embodiment of this invention, one feature of silver halide grains is that silver halide grains form latent images capable of acting as a catalyst in development upon exposure to light prior to thermal development on the silver halide grain surface, and upon exposure after completion of thermal development, images are formed preferentially in the interior of the grains (i.e., internal latent image formation), thereby suppressing latent image formation on the grain surface.

In general, when exposed to light, light-sensitive silver halide grains or spectral sensitizing dyes adsorbed onto the surfaces of the silver halide grains are photoexcited to form free electrons. The thus formed electrons are trapped competitively by electron traps on the grain surface (sensitivity center) and internal electron traps existing in the interior of the grains. In cases when chemical sensitization centers (chemical sensitization nuclei) or dopants useful as a electron trap exist more on the surface than the interior of the grain, latent images are more predominantly on the surface than in the interior of the grain, rendering the grains developable. On the contrary, the chemical sensitization centers or dopants useful as electron traps, which exist more in the interior than the surface of the grains form latent images preferentially in the interior rather than the surface of the grains, rendering the grain undevelopable. Alternatively, it can be said that, in the former case, the grain surface has higher sensitivity than the interior; in the latter case, the surface has lower sensitivity than the interior.

In one preferred embodiment of this invention, light-sensitive silver halide grains each internally contains an electron-trapping dopant. Thus, it is preferred to cause an electron trapping dopant to be occluded in the interior of light-sensitive silver halide grains, resulting in enhanced sensitivity and improved image storage stability.

Techniques for occluding an appropriate dopant in the interior of light-sensitive silver halide grains are not specifically limited, including, for example, the method described in JP-A No. 9-43765 and 2001-42471. Dopants including those used in conventional silver halide photographic material are known as an electron trapping or hole trapping one. However, nothing is taught therein with respect to properties of surface sensitivity and internal sensitivity in the embodiment of exposure and thermal development using a silver salt photothermographic material, as defined in this invention. The electron trapping dopant is an element or compound, except for silver and halogen forming silver halide, referring to one having a property of trapping free electrons or one whose occlusion within the grain causes a site such as an electron-trapping lattice imperfection. Examples thereof include metal ions except for silver and their salts or complexes; chalcogens (elements of the oxygen group) such as sulfur, selenium and tellurium; chalcogen or nitrogen containing organic or inorganic compounds; and rare earth ions or their complexes.

Examples of the metal ions and their salts or complexes include a lead ion, bismuth ion and gold ion; lead bromide, lead carbonate, lead sulfate, bismuth nitrate, bismuth chloride, bismuth trichloride, bismuth carbonate, sodium bismuthate, chloroauric acid, lead acetate, lead stearate and bismuth and acetate.

Compounds containing chalcogen such as sulfur, selenium or tellurium include various chalcogen-releasing compounds, which are known, in the photographic art, as a chalcogen sensitizer. The chalcogen0 or nitrogen-containing organic compounds are preferably heterocyclic compounds. Examples thereof include imidazole, pyrazole, pyridine, pyrimidine, pyrazine, pyridazine, triazole, triazine, indole, indazole, purine, thiadiazole, oxadiazole, quinoline, phthalazine, naphthyridine, quinoxaline, quinazoline, cinnoline, pteridine, acridine, phenanthroline, phenazine, tetrazole, thiazole, oxazole, benzimidazole, benzoxazole, benzthiazole, indolenine, and tetrazaindene; preferred of these are imidazole, pyridine, pyrazine, pyridazine, triazole, triazine, thiadiazole, oxadiazole, quinoline, phthalazine, naphthyridine, quinoxaline, quinazoline, cinnoline, tetrazole, thiazole, oxazole, benzimidazole, benzoxazole, benzthiazole, and tetrazaindene. The foregoing heterocyclic compounds may be substituted with substituents. Examples of substituents include an alkyl group, alkenyl group, aryl group, alkoxy group, aryoxy group, acyloxy group, acyl group, alkoxycarbonyl group, aryloxycarbonyl group, acyloxy group, acylamino group, alkoxycarbonylamino group, aryloxycarbonylamino group, sulfonylamino group, sulfamoyl group, carbamoyl group, sulfonyl group, ureido group, phosphoric acid amido group, halogen atoms, cyano group, sulfo group, carboxyl group, nitro group, and heterocyclic group; of these, an alkyl group, aryl group, alkoxy group, aryoxy group, acyl group, acylamino group, alkoxycarbonylamino group, sulfonylamino group, sulfamoyl group, carbamoyl group, sulfonyl group, ureido group, phosphoric acid amido group, halogen atoms, cyano group, nitro group and heterocyclic group are preferred; and an alkyl group, aryl group, alkoxy group, aryoxy group, acyl group, acylamino group, sulfonylamino group, sulfamoyl group, carbamoyl group, halogen atoms, cyano group, nitro group, and heterocyclic group are more preferred.

Silver halide grains used in this invention may be occluded with transition metal ions selected from group 6 to 11 of the periodical table whose oxidation state is chemically prepared in combination with ligands so as to function as an electron-trapping dopant and/or a hole-trapping dopant. Preferred transition metals include W, Fe, Co, Ni, Cu, Ru, Rh, Pd, Re, Os, Ir and Pt.

The foregoing dopants may be used alone or in combination thereof. The dopants can be introduced, in any chemical form, into silver halide grains. The dopant content is preferably 1×10⁻⁹ to 1×10 mol, more preferably 1×10⁻⁸ to 1×10⁻¹ mol, and still more preferably 1×10⁻⁶ to 1×10⁻² mol per mol of silver. The optimum content, depending on the kind of the dopant, grain size or form of silver halide grains and other environmental conditions, can be optimized in accordance with the foregoing conditions.

In the present invention, transition metal complexes or their ions, represented by the general formula described below are preferred:

Formula: (ML₆)^{m}:

wherein M represents a transition metal selected from elements in Groups 6 to 11 of the Periodic Table; L represents a coordinating ligand; and m represents 0,1-, 2-, 3- or 4-. M is selected preferably from W, Fe, Co, Ni, Cu, Ru, Rh, Pd, Re, Os, Ir and Pt. Exemplary examples of the ligand represented by L include halides (fluoride, chloride, bromide, and iodide), cyanide, cyanato, thiocyanato, selenocyanato, tellurocyanato, azido and aquo, nitrosyl, thionitrosyl, etc., of which aquo, nitrosyl and thionitrosyl are preferred. When the aquo ligand is present, one or two ligands are preferably coordinated. L may be the same or different.

Compounds, which provide these metal ions or complex ions, are preferably incorporated into silver halide grains through addition during the silver halide grain formation. These may be added during any preparation stage of the silver halide grains, that is, before or after nuclei formation, growth, physical ripening, and chemical ripening. However, these are preferably added at the stage of nuclei formation, growth, and physical ripening; furthermore, are preferably added at the stage of nuclei formation and growth; and are most preferably added at the stage of nuclei formation. These compounds may be added several times by dividing the added amount. Uniform content in the interior of a silver halide grain can be carried out. As disclosed in JP-A No. 63-29603, 2-306236, 3-167545, 4-76534, 6-110146, 5-273683, the metal can be non-uniformly occluded in the interior of the grain.

These metal compounds can be dissolved in water or a suitable organic solvent (e.g., alcohols, ethers, glycols, ketones, esters, amides, etc.) and then added. Furthermore, there are methods in which, for example, an aqueous metal compound powder solution or an aqueous solution in which a metal compound is dissolved along with NaCl and KCl is added to a water-soluble silver salt solution during grain formation or to a water-soluble halide solution; when a silver salt solution and a halide solution are simultaneously added, a metal compound is added as a third solution to form silver halide grains, while simultaneously mixing three solutions; during grain formation, an aqueous solution comprising the necessary amount of a metal compound is placed in a reaction vessel; or during silver halide preparation, dissolution is carried out by the addition of other silver halide grains previously doped with metal ions or complex ions. Specifically, the preferred method is one in which an aqueous metal compound powder solution or an aqueous solution in which a metal compound is dissolved along with NaCl and KCl is added to a water-soluble halide solution. When the addition is carried out onto grain surfaces, an aqueous solution comprising the necessary amount of a metal compound can be placed in a reaction vessel immediately after grain formation, or during physical ripening or at the completion thereof or during chemical ripening. Non-metallic dopants can also be introduced in a manner similar to the foregoing metallic dopants.

Whether a dopant has an electron-trapping property in the photothermographic material relating to this invention can be evaluated according to the following manner known in the photographic art. A silver halide emulsion comprising silver halide grains doped with a dopant is subjected to microwave photoconductometry to measure photoconductivity. Thus, the doped emulsion can be evaluated with respect to a decreasing rate of photoconductivity on the basis of a silver halide emulsion containing no dopant. Evaluation can also be made based on comparison of internal sensitivity and surface sensitivity.

One feature of this invention concerns that the photothermographic material of this invention meets the following requirement regarding sensitivity:

S_{B}/S_{A}≦0.2

wherein S_{A} represents a sensitivity btained when the photothermographic material is subjected to imagewise exposure and thermal development, and S_{B} represents a sensitivity obtained when, prior the foregoing imagewise exposure and thermal development, the photothermographic material is subjected to a heat treatment, and then further subjected to the imagewise exposure and thermal development.

The foregoing characteristic can be evaluated in the following manner. Thus, the photothermographic material is subjected to a heat treatment at a temperature of 110° C. for a period of 15 sec., followed by being exposed to white light (e.g., light at 4874K) or infrared light through an optical wedge for a prescribed period of time (within the range of 0.01 sec. to 30 min., e.g., 30 sec) using a tungsten light source and being thermally developed at a temperature of 110° C. for a period of 15 sec. The thus processed photothermographic material is further subjected to densitometry with respect to developed silver image to prepare a characteristic curve comprising an abscissa of exposure and an ordinate of silver density and based thereon, sensitivity is determined, which is designated as S_{B}. Separately, the photothermographic material is exposed and thermally developed in the same manner as above, without being subjected to the heat treatment to determine sensitivity, which is designated S_{A}. The sensitivity is defined as the reciprocal of an exposure amount giving a density of a minimum density (or a density of the unexposed area) plus 1.0.

In this invention, the ratio of S_{B}/S_{A} is not more than 0.2, preferably not more than 0.1, and more preferably 0.01 to 0.05. The less S_{B}/S_{A} is more preferred in this invention. Specifically, the use of a silver halide emulsion comprising silver halide grains doped with an electron-trapping dopant results in markedly decreased S_{B}/S_{A}, leading to advantageous effects of this invention.

Silver halide may be incorporated into an image forming layer by any means, in which silver halide is arranged so as to be as close to reducible silver source (aliphatic carboxylic acid silver salt) as possible. It is general that silver halide, which has been prepared in advance, added to a solution used for preparing an organic silver salt. In this case, preparation of silver halide and that of an organic silver salt are separately performed, making it easier to control the preparation thereof. Alternatively, as described in British Patent 1,447,454, silver halide and an organic silver salt can be simultaneously formed by allowing a halide component to be present together with an organic silver salt-forming component and by introducing silver ions thereto. Silver halide can also be prepared by reacting a halogen containing compound with an organic silver salt through conversion of the organic silver salt. Thus, a silver halide-forming component is allowed to act onto a pre-formed organic silver salt solution or dispersion or a sheet material containing an organic silver salt to convert a part of the organic silver salt to photosensitive silver halide.

The silver halide-forming components include inorganic halide compounds, onium halides, halogenated hydrocarbons, N-halogeno compounds and other halogen containing compounds. These compounds are detailed in U.S. Pat. No. 4,009,039, 3,457,075 and 4,003,749, British Patent 1,498,956 and JP-A 53-27027 and 53-25420. Exemplary examples thereof include inorganic halide compound such as a metal halide and ammonium halide; onium halides, such as trimethylphenylammonium bromide, cetylethyldimethylammonium bromide, and trimethylbenzylammonium bromide; halogenated hydrocarbons, such as iodoform, bromoform, carbon tetrachloride and 2-brom-2-methylpropane; N-halogenated compounds, such as N-bromosucciimde, N-bromophthalimide, and N-bromoacetoamide; and other halogen containing compounds, such as triphenylmethyl chloride, triphenylmethyl bromide, 2-bromoacetic acid, 2-bromoethanol and dichlorobenzophenone. As described above, silver halide can be formed by converting a part or all of an organic silver salt to silver halide through reaction of the organic silver salt and a halide ion. The silver halide separately prepared may be used in combination with silver halide prepared by conversion of at least apart of an organic silver salt. The silver halide which is separately prepared or prepared through conversion of an organic silver salt is used preferably in an amount of 0.001 to 0.7 mol, and more preferably 0.03 to 0.5 mol per mol of organic silver salt.

Silver halide grain emulsions used in the invention may be desalted after the grain formation, using the methods known in the art, such as the noodle washing method and flocculation process.

The light-insensitive silver salt of an aliphatic carboxylic acid silver salts relating to this invention will be described. The light-insensitive silver salts of aliphatic carboxylic carboxylic acids (hereinafter, denoted as silver salts of fatty acids and also denoted as silver aliphatic carboxylates or organic silver salts) are reducible silver source, and silver salts of organic acids are preferred and silver salts of long chain aliphatic carboxylix acid (also called fatty carboxylic acid or simply fatty acid) having 10 to 30 carbon atom, preferably 15 to 25 carbon atoms are more preferred. Examples of silver salt of long chain aliphatic carboxylic acids include silver salts of gallic acid, citric acid, behenic acid, stearic acid, arachidic acid, palmitic acid and lauric acid, and of these, silver behenate, silver arachidate and silver stearate are preferred.

The combined use of at least two kinds of silver salts of aliphatic carboxylic acids is preferable to enhance developability and to form images with high density and high contrast. For example, such silver salts can be prepared by adding an aqueous silver salt solution to a mixture of at least two kinds of fatty acids. On the other hand, it is preferred from the point of view of image lasting quality that the content of silver salts of aliphatic carboxylic acids exhibiting a melting point of 50° C. or more (preferably 60° C. or more) is at least 60% (more preferably at least 70% and still more preferably at least 80%). In view thereof, the higher content of silver behenate is more preferable.

Aliphatic carboxylic acid silver salts can be obtained by mixing an aqueous-soluble silver compound with a compound capable of forming a complex. Normal precipitation, reverse precipitation, double jet precipitation and controlled double jet precipitation, as described in JP-A 9-127643 are preferably employed. For example, to an organic acid can be added an alkali metal hydroxide (e.g., sodium hydroxide, potassium hydroxide, etc.) to form an alkali metal salt soap of the organic acid (e.g., sodium behenate, sodium arachidate, etc.), thereafter, the soap and silver nitrate are mixed by the controlled double jet method to form organic silver salt crystals. In this case, silver halide grains may be concurrently present.

Silver salts of aliphatic carboxylic acids used in this invention may be crystalline particles having a core/shell structure, as described in European Patent No. 1,168,069A1 and JP-A No. 2002-23303. In such a core/shell structure, all or at least a part of the core or shell may be comprised of a silver salt of an organic acid other than aliphatic carboxylic acids, such as phthalic acid or benzimidazole.

The silver salt of a aliphatic carboxylic acid usable in this invention preferably an average equivalent circular diameter of 0.05 to 0.8 μm (more preferably 0.2 to 0.5 μm) and an average thickness of 0.005 to 0.07 μm (0.01 to 0.05 μm). The average equivalent circular diameter of less than 0.05 μm results in superior transparency but deteriorated image storage stability. The average grain size of more than 0.8 μm causes marked haze. In the case of an average thickness of less than 0.005 μm, an increased surface area causes an abrupt supply of silver ions, resulting in a large amount of silver ions remaining in the layer without being used as a silver image and leading to deteriorated silver image storage stability. The average thickness of more than 0.07 μm results in a decreased surface area, leading to enhanced image stability but retarded silver supply results in non-uniform developed silver forms, often leading to a decreased maximum density.

The grain diameter was determined in the following manner. An organic silver salt dispersion was diluted, dispersed on the grid provided with a carbon support membrane, and then photographed at a direct magnification of 5,000 times using a transmission type electron microscope (TEM, 2000 FX type, available from Nihon Denshi Co., Ltd.). The thus obtained negative electron micrographic images were read as a digital image by a scanner to determine the diameter (circular equivalent diameter) using appropriate software. At least 300 grains were so measured to determine an average diameter.

The grain thickness is determined using a transmission type electron microscope (TEM) in the conventional manner.

Details of other means such as electron microscopic technology and sample preparation techniques can be referred to in “Igaku•Seibutsugaku Denshikenbikyo Kansatsuho (Medical and Biological Electron Microscopy”, edited by Nippon Denshikenbikyo Gakkai, Kanto-Shibu, (Maruzen), and “Denshikenbikyo Seibutsu Shiryo Sakuseiho (Preparation Method of Biological Samples for Electron Microscopy)”, edited by Nippon Denshikenbikyo Gakkai, Kanto-Shibu, (Maruzen).

The TEM image, recorded in an appropriate medium, is decomposed to at least 1024×1024 pixels or preferably at least 2048×2048 pixels, and is then subjected to image processing employing a computer. In order to carry out image processing, an analogue image recorded on a film strip is converted into a digital image employing a scanner etc., and the resulting image is preferably subjected to shading correction, contrast-edge enhancement, etc., based on specific requirements. Thereafter, a histogram is prepared and the portions corresponding to organic silver are extracted employing binary processing. At least 300 grains of the organic silver salt were manually measured with respect to the thus extracted thickness employing appropriate software.

The method for preparing aliphatic carboxylic acid silver salt grains having the shape described above is not specifically limited. The optimization of various conditions such as maintaining the mixing state during the formation of an organic acid alkali metal salt soap and/or the mixing state during the addition of silver nitrate to said soap.

In this invention, it is preferred that the tabular silver salt grains of a aliphatic carboxylic acid (having an average equivalent circular diameter of 0.05 to 0.8 μm and an average thickness of 0.005 to 0.07 μm), after subjecting to preliminary dispersion using a binder or surfactants, be pulverized using a media dispersing machine or high-pressure homogenizer. During the preliminary dispersion, ordinary stirrers such as an anchor type, a propeller type, etc., a high-speed rotation centrifugal radial type stirrer (Dissolver), and a high speed shearing stirrer (homo-mixer) may be employed. Furthermore, employed as the media homogenizer may be rolling mills such as a ball mill, a satellite ball mill, a vibrating ball mill, medium agitation mills such as a bead mill, atriter, and others such as a basket mill. Employed as high pressure homogenizer may be various types such as a type in which collision occurs against a wall or a plug, a type in which liquid is divided into a plurality of portions and said portions are subjected to collision with each other, a type in which liquid is forced to pass through a narrow orifice, etc. Examples of ceramics employed as the ceramic beads include Al2O3, BaTiO3, SrTiO3, MgO, ZrO, BeO, Cr2O3, SiO3, SiO2-Al2O3, Cr2O3-MgO, MgO—CaO, MoO—C, MgO—Al2O3 (spinel), SiC, TiO2, K2O, Na2O, BaO, PbO, B2O3, BeAl2O4, Y3Al5O12, ZrO2-Y2O3 (cubic zirconia), 3BeO-Al203-6SiO2 (artificial emerald), C (artificial diamond), SiO2-nH₂O, silicone nitride, yttrium-stabilized-zirconia, zirconia-reinforced-alumina. Yttrium-stabilized-zirconia and zirconia-reinforced-alumina are preferably employed in view that little impurity is generated by friction among the beads or the classifier during classifying them. The ceramics containing zirconia are called zirconia as an abbreviation.

In devices employed for dispersing the tabular silver salt grains of a aliphatic carboxylic acid employed in this invention, preferably employed as the members which are in contact with the organic silver salt grains are ceramics such as zirconia, alumina, silicone nitride, boron nitride, or diamond. Of these, zirconia is the one most preferably employed. While carrying out of the above-mentioned dispersion, the binder is preferably added so as to achieve a concentration of 0.1 to 10 wt % with reference to the weight of the organic silver salt, and the temperature is preferably maintained at no less than 45° C. from the preliminary dispersion to the main dispersion process. An example of the preferable operation conditions of a homogenizer, when employing high-pressure homogenizer as the dispersing machine, is twice or more operations at 300 to 1,000 kgf/cm². In the case when a media-dispersing machine is employed, a circumferential speed of 6 to 13 m/sec. is preferable.

It is preferred to prepare the light-insensitive silver salt grains of an aliphatic carboxylic acid in the presence of compounds functioning as a crystal growth inhibitor or dispersing agent. Such compounds functioning as a crystal growth inhibitor or dispersing agent are preferably those which contain a hydroxyl group or carboxyl group.

In the preparation process of organic silver salt grains, it is preferred to prepare aliphatic carboxylic acid silver salt grains concurrently in the presence of a compound capable of functioning as a crystal growth retarding agent or dispersing agent for the aliphatic carboxylic acid silver salt grains. The compound capable of functioning as a crystal growth retarding agent or dispersing agent for aliphatic carboxylic acid silver salt grains refers to one which has a function or effect of forming grains with reduced size and enhanced uniformity thereof when prepared in the presence of the compound, as compared to the absence thereof. Specific examples of such compounds include monohydric alcohols having 10 or less carbon atoms (preferably secondary and tertiary alcohols), glycols such as ethylene glycol and propylene glycol, poly-ethers such as polyethylene glycol, and glycerin. Such compounds are added in an amount of 10 to 200% by weight, based on aliphatic carboxylic acid silver salt.

Branched aliphatic carboxylic acids including isomers thereof are also preferable, such as iso-heptanoic acid, iso-decanoic acid, iso-tridecanoic acid, iso-myristic acid, iso-palmitic acid, iso-stearic acid, iso-arachidic acid, iso-behenic acid and iso-hexanoic acid. In this case, a preferable branched chain is an alkyl or alkenyl group having 4 or less carbon atoms. Further, unsaturated aliphatic carboxylic acids are cited, such as palmothreic acid, oleic acid, linolic acid, linoleic acid, moroctic acid, eicosenic acid, arachidonic acid, eicopentaenic acid, erucic acid, docosapentaenic acid, and selacholeic acid. These compounds are added in an amount of 0.5 to 10 mol %, based on aliphatic carboxylic acid silver salt.

Preferred compounds include glycosides such as gluciside, galactoside and fructoside; trehalose type disaccharides such as trahalose and sucrose; polysaccharides such as glycogen, dextrin, dextran and alginic acidcellosolves such as methyl cellosolve and ethyl cellosolve; wate-soluble organic solvents such as sorbitan, sorbitol, ethyl acetate, methyl acetate, and dimethyl formamide; water-soluble polymers such as polyvinyl alcohol, polyacrylic acid, acrylic acid copolymer, maleic acid copolymer, carboxymethyl cellulose, hydroxypropyl cellulose, hydroxypropylmethyl cellulose, polyvinyl pyrrolidone and gelatin. These compounds are added preferably in an amount of 0.1 to 20% by weight.

Alcohols having 10 or less carbon atoms are preferred, and the use of secondary or tertiary alcohols enhances solubility of sodium salt of an aliphatic carboxylic acid, resulting in reduced viscosity and enhancing stirring efficiency, leading to formation of monodisperse fine grains. Branched aliphatic carboxylic acids and unsaturated carboxylic acids exhibit higher steric hindrance than straight chain aliphatic carboxylic acids, resulting in fine crystals due to increased disorder in crystal lattice.

With regard to the difference in constitution between a conventional silver salt photographic material and a photothermographic imaging material, the photothermographic imaging material contains relatively large amounts of light sensitive silver halide, a carboxylic acid silver salt and a reducing agent which often cause fogging and silver printing-out (print out silver). In the photothermographic imaging material, therefore, an enhanced technique for antifogging and image-lasting is needed to maintain storage stability not only before development but also after development. In addition to commonly known aromatic heterocyclic compounds to restrain growth of fog specks and development thereof, there were used mercury compounds having a function of allowing the fog specks to oxidatively die away. However, such a mercury compound causes problems with respect to working safety and environment protection.

Next, antifoggants and image stabilizers used in the photothermographic imaging material relating to the invention will be described.

In photothermographic materials relating to this invention are employed reducing agents containing a proton, such as bisphenols and sulfonamidophenols. Accordingly, a compound generating a labile species which is capable of abstracting a proton to deactivate the reducing agent is preferred. More preferred is a compound as a non-colored photo-oxidizing substance, which is capable of generating a free radical as a labile species on exposure. Any compound having such a function is applicable. However, a halogen radical, which easily forms silver halide is not preferred. An organic free radical composed of plural atoms is preferred. Any compound having such a function and exhibiting no adverse effect on the photothermographic material is usable irrespective of its structure. Of such free radical generation compounds, a compound containing an aromatic, and carbocyclic or heterocyclic group is preferred, which provides stability to the generated free radical so as to be in contact with the reducing agent for a period sufficient to react with the reducing agent to deactivate it. Representative examples of such compounds are described in JP-A No. 2000-321711. The compound is incorporated preferably in an amount of 10⁻³ to 10⁻¹ mol/m², and more preferably 5×10⁻³ to 5×10⁻² mol/m². The compound may be incorporated into any component layer of the photothermographic material relating to the invention and is preferably incorporated in the vicinity of a reducing agent.

As a compound capable of deactivating a reducing agent to inhibit reduction of an organic silver salt to silver by the reducing agent are preferred compounds releasing a labile species other than a halogen atom. However, these compounds may be used in combination with a compound capable of releasing a halogen atom as a labile species.

Further, in addition to the foregoing compounds, compounds commonly known as an antifoggant may be incorporated in the photothermographic imaging material used in the invention. In such a case, the compounds may be those which form a labile species similarly to the foregoing compounds or those which are different in antifogging mechanism. Examples thereof include compounds described in U.S. Pat. Nos. 3,589,903,4,546,075 and 4,452,885; JP-A No. 59-57234; U.S. Pat. Nos. 3,874,946 and 4,756,999; and JP-A Nos. 9-288328 and 9-90550. Further, other antifoggants include, for example, compounds described in U.S. Pat. No. 5,028,523 and European patent Nos. 600,587, 605,981 and 631,176. Furthermore, there can also preferably used compounds capable of forming a chelate ring with a silver ion, such as phthalic acids, which contain two carboxyl groups at the adjacent positions, capable of forming a chelate ring.

At least one of reducing agents for silver ions, used in the photothermographic material of this invention is preferably a bisphenol derivative, which can be used alone or in combination with other reducing agents, whereby the photothermographic material relating to this invention can unexpectedly be improved in deteriorated performance, such as fogging during storage and deteriorated silver image tone after storage.

Examples of reducing agents suitable for the photothermographic material of this invention are disclosed in U.S. Pat. Nos. 3,770,448, 3,773,512 and 3,593,863; Research Disclosure (hereinafter, denoted simply as RD) Nos. 17029 and 29963. Of commonly known reducing agents, optimally selected ones can be used in this invention. In cases where a silver salt of a aliphatic carboxylic acid is used as an organic silver salt, there can be used polyphenols in which at least two phenol moieties are linked with an alkylene group or sulfur atom(s), specifically, at least two phenol moieties, which are each substituted at the position adjacent to the phenolic hydroxyl group by an alkyl group (e.g., methyl, ethyl, propyl, t-butyl, cyclohexyl, etc.) or an acyl group (e.g., acetyl, propionyl, etc.) and which are linked by an alkylene group or sulfur atom.

Reducing agents usable in this invention are those that are represented by the following formula (A-1):

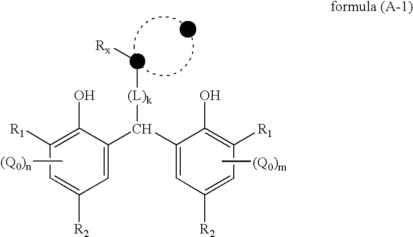

wherein R₁ and R₂ each represent a group capable of being substituted on a benzene ring; Q₀ represents a group capable of being substituted on a benzene ring; n is 0, 1 or 2, provided that when n is 2, two Qs may be the same or different; Rₓ represents a hydrogen atom, an alkyl or cycloalkyl group or an alkenyl or cycloalkenyl group; Z represents an atomic group necessary to form a 3- to 10-membered ring; L represents a bivalent linkage group; k is 0 or 1.

In the foregoing formula (A-1), the 3- to 10-membered ring is preferably a non-aromatic ring. Of the 3- to 10-membered non-aromatic ring groups, 3-membered non-aromatic ring groups include, for example, cyclopropyl, aziridyl and oxiranyl; 4-membered ring groups include cyclobutyl, cyclobutenyl, oxetanyl and azetiddinyl; 5-membered ring groups include cyclopentyl, cyclopentenyl, cyclopentadienyl, tetrahydrofuranyl, pyrrolidinyl and tetrahydrothienyl; 6-membered ring groups include cyclohexyl, cyclohexenyl, cyclohexadienyl, tetrahydropiranyl, piperidinyl, dioxanyl, tetrahydrothiopyranyl, norcaranyl, norpiranyl and norbonyl; 7-membered ring groups include cycloheptyl, cycloheptenyl and cycloheptadienyl; 8-membered ring groups include cyclooctanyl, cyclooctenyl, cyclootadienyl and cyclooctatrienyl; 9-membered ring groups include cyclononanyl, cyclononenyl, cyclononadienyl and cyclononatrienyl; 10-membered ring groups include cyclodecanyl, cyclodecenyl, cyclodecadienyl andcyclodecatrienyl. Of the foregoing 3- to 10-membered ring groups, 3- to 6-membered ring groups are preferred, 5- and 6-membered ring groups are more preferred, and a 6-membered ring group is still more preferred. Further, hydrocarbon rings containing no heteroatom are specifically preferred. These rings may form a spiro-bonding through a spiro atom or may be condensed with other rings including an aromatic ring.

The foregoing ring groups may be substituted. Examples of substituent groups include a halogen atom (e.g., fluorine, chlorine, bromine), cycloalkyl group (e.g., cyclohexyl, cycloheptyl), cycloalkenyl group (e.g., 1-cyclalkenyl, 2-cycloalkenyl), alkoxy group (e.g., methoxy, ethoxy, propoxy), alkylcarbonyloxy group (e.g., acetyloxy), alkylthio group (e.g., methylthio, trifluoromethylthio), carboxyl group, alkylcarbonylamino group (e.g., acetylamino), ureido group (e.g., methylaminocarbonylamino), alkylsulfonyl group (e.g., methanesulfonyl, trifluoromethanesulfonyl), carbamoyl group (e.g., carbamoyl, N,N-dimethylcarbamoyl, N-morpholinocarbonyl), sulfamoyl group (e.g., sulfamoyl, N,N-dimethylsulfamoyl, morpholinosulfamoyl), trifluoromethyl, hydroxy, nitro, cyano, alkylsulfonamido group (e.g., methanesulfonamido, butanesulfoneamido), alkylamino group (e.g., N,N-dimethylamino, N,N-diethylamino), sulfo group, phosphono group, sulfite group, sulfino group, alkylsulfonylaminocarbonyl group (e.g., methanesulfonylaminocarbonyl, ethanesulfonylaminocarbonyl), alkylcarbonylaminosulfonyl group (e.g., acetoamidosulfonyl, methoxyacetoamidosulfonyl), alkynylaminocarbonyl group (e.g., acetoamidocarbonyl, methoxyacetoamidocarbonyl), and alkylsulfinylaminocarbonyl group (e.g., methanesulfinylaminocarbonyl, ethane sulfinylaminocarbonyl). In the case of being substituted by plural substituents, the plural substituents may be the same or different. Of the foregoing substituent groups, an alkyl group is specifically preferred.

R₁ and R₂ are each a group capable of being substituted on a benzene ring. Examples thereof include a hydrogen atom, an alkyl group, cycloalkyl group, alkenyl group, cycloalkenyl group, aryl group or heterocyclic group. The alkyl group is preferably one having 1 to 10 carbon atoms. Examples thereof include methyl, ethyl, propyl, iso-propyl, butyl, t-butyl, pentyl, iso-pentyl, 2-ethyl-hexyl, octyl, decyl, cyclohexyl, cyclopropyl, 1-methylcyclohexyl, ethenyl-2-prppenyl, 3-butenyl, 1-methyl-3-propenyl, 3-pentenyl, 1-methyl-3-butenyl, 1-cycloalkenyl group, 2-cycloalkenyl group, ethynyl and 1-propynyl. R₁₃ is preferably methyl, ethyl, iso-propyl, t-butyl, cyclohexyl, and 1-methylcyclohexyl, more preferably methyl, t-butyl, and 1-methylcyclohexyl, and still more preferably t-butyl and 1-methylcyclohexyl. R₁₄ is preferably methyl, ethyl, iso-propyl, t-butyl, cyclohexyl, 1-methylcyclohexyl, and 2-hydroxyethyl, and more preferably methyl and 2-hydroxyethyl. Examples of an aryl group represented by R₁₃ and R₁₄ include phenyl, naphthyl and anthranyl group. Examples of a heterocyclic group represented by R₁₃ and R₁₄ include aromatic heterocyclic groups such as a pyridine group, quinoline group, isoquinoline group, imidazole group, pyrazole group, triazole group, oxazole group, thiazole group, oxadiazole group, thiadiazole group, and tetrazole group, and non-aromatic heterocyclic groups such as piperidino, morpholino group, tetrahydrofuryl, tetrahydrothienyl, and tetrahydropyranyl. These groups may be substituted, and substituent are the same as described above. The most preferable combination of R₁₃ of a tertiary alkyl group (e.g., t-butyl, 1-methylcyclohexyl) and R₁₄ of a primary alkyl group (e.g., methyl, 2-hydroxyethyl) is most preferred. Plural R₁s or R₂s may be the same or different and preferably methyl.

Rₓ represents a hydrogen atom, an alkyl or cycloalkyl group or an alkenyl or cycloalkenyl group. The alkyl or cycloalkyl group and the alkenyl and cycloalkenyl group are preferably those having 1 to 10 carbon atoms, including methyl, ethyl, propyl, iso-propyl, butyl, t-butyl, pentyl, iso-pentyl, 2-ethylhexyl, octyl, decyl, cyclohexyl, cycloheptyl, 1-methylcyclohexyl, ethenyl-2-propenyl, 3-butenyl, 1-methyl-3-propenyl, 3-pentenyl, 1-methyl-3-butenyl, 1-cycloalkenyl, 2-cycloalkenyl, ethynyl and 1-propynyl. Of these, methyl, ethyl and iso-propyl are preferred.

Q₀ is a group capable of being substituted on a benzene ring. Specific example thereof include an alkyl group having 1 to 25 carbon atoms (e.g., methyl, ethyl, propyl, iso-propyl, t-butyl, pentyl), halogenated alkyl group (e.g., trifluoromethyl, perfluorooctyl), cycloalkyl group (e.g., cyclohexyl, cyclopentyl), alkynyl group (e.g., propargyl), glycidyl group, acrylate group, methacrylate group, aryl group (e.g., phenyl), heterocyclic group (pyridyl, thiazolyl, pyrimidyl, pyridadinyl, selenazolyl, sulfolanyl, piperidinyl, pyrazolinyl, pyrazolyl, tetrazolyl), halogen atom (e.g., chlorine, bromine, iodine, fluorine), alkoxy group (e.g., methoxy, ethoxy, propyloxy, pentyloxy, cyclopentyloxy, hexyloxy, cyclohexyloxy), aryloxy group (e.g., phenoxy), alkoxycarbonyl group (e.g., methyloxycarbonyl, ethyloxycarbonyl, butyloxycarbonyl), aryloxycarbonyl group (e.g., phenyloxycarbonyl), sulfoneamido group (e.g., methanesulfoneamido, ethanesulfoneamido, butanesulfoneamido, hexanesulfoneamido, cycohexanesulfoneamido, benzenesulfoneamido), sulfamoyl group (e.g., aminosulfonyl, methylaminosulfonyl, dimethylaminosulfonyl, butylaminosulfonyl, hexylaminosulfonylcyclohexylaminosulfonyl, phenylaminosulfonyl, 2-pyridylaminosulfonyl), urethane group (e.g., methylureido, ethylureido, pentylureido, cylohexylureido, phenylureido, 2-pyridylureido), acyl group (e.g., acetyl, propionyl, butanoyl, hexanoyl, cyclohexanoyl, benzoyl, pyridinoyl), carbamoyl group (e.g., aminocarbonyl, methylaminocarbonyl, dimethylaminocarbonyl, propylaminocarbonyl, pentylaminocarbonyl, cyclohexylaminocarbonyl, phenylamiocarbonyl, 2-pyridylaminocarbonyl), amido group (e.g., acetoamide, propioneamido, butaneamido, hexaneamido, benzamido), sulfonyl group (e.g., methylsulfinyl, ethylsulfinyl, butylsulfonyl, cyclohexylsulfonyl, phenylsulfinyl, 2-pyridylsulfonyl), amino group (e.g., amino, ethylamino, dimetylamino, butylamino, cyclopentylamino, anilino, 2-pyridylamino), cyano, nitro, sulfo, carboxyl, hydroxy, and oxamoyl. These groups may further be substituted by the foregoing group. In the formula (A-4), n and m are each 0, 1 or 2, and both of n and m are preferably 0.

L is a bivalent linkage group, preferably an alkylene group such as methylene, ethylene or propylene, and more preferably an alkylene group having 1 to 20 carbon atom (preferably 1 to 5 carbon atoms); k is 0 or 1 and preferably 0.

The amount of a reducing agent for silver ions to be used in photothermographic materials relating to this invention, depending on the kind of organic silver salts, reducing agent, or other additives is usually 0.05 to 10 mol, and preferably 0.1 to 3 mol per mol of organic silver salt. One or more reducing agents may be used in combination, in an amount within the foregoing range. Addition of the reducing agent to a light sensitive emulsion comprising a light sensitive silver halide, organic silver salt grains and a solvent immediately before coating the emulsion is often preferred, thereby minimizing variation in photographic performance during standing.

Silver halide grains used in the invention can be subjected to chemical sensitization. In accordance with methods described in Japanese Patent Application Nos. 2000-57004 and 2000-61942, for example, a chemical sensitization center (chemical sensitization speck) can be formed using compounds capable of releasing chalcogen such as sulfur or noble metal compounds capable of releasing a noble metal ion such as a gold ion. In the invention, it is preferred to conduct chemical sensitization with an organic sensitizer containing a chalcogen atom, as described below. Such a chalcogen atom-containing organic sensitizer is preferably a compound containing a group capable of being adsorbed onto silver halide and a labile chalcogen atom site. These organic sensitizers include, for example, those having various structures, as described in JP-A Nos. 60-150046, 4-109240 and 11-218874. Specifically preferred of these is at least a compound having a structure in which a chalcogen atom is attacked to a carbon or phosphorus atom through a double bond. The amount of a chalcogen compound added as an organic sensitizer is variable, depending on the chalcogen compound to be used, silver halide grains and a reaction environment when subjected to chemical sensitization and is preferably 10⁸ to 10² mol, and more preferably 10⁷ to 10³ mol per mol of silver halide.

In addition to the foregoing sensitization, reduction sensitization can also be employed and exemplary compounds for reduction sensitization include ascorbic acid, thiourea dioxide, stannous chloride, hydrazine derivatives, borane compounds, silane compounds and polyamine compounds. Reduction sensitization can also conducted by ripening the emulsion while maintaining the pH at not less than 7 or the pAg at not more than 8.3. Silver halide to be subjected to chemical sensitization may be one which has been prepared in the presence of an organic silver salt, one which has been formed under the condition in the absence of the organic silver salt, or a mixture thereof.

It is also preferred that chemical sensitization be given onto the surface of the light-sensitive silver halide grain and the chemical sensitization effect be substantially dissipated after being subjected to thermal development. The expression, chemical sensitization effect being substantially dissipated means that the speed of the photothermographic material, obtained by the chemical sensitization decreases, after thermal development, to less than 1.1 times that of the photothermographic material which has not been subjected to chemical sensitization.

Light sensitive silver halide grains used in the invention are preferably subjected to spectral sensitization by allowing a spectral sensitizing dye to adsorb to the grains. Examples of the spectral sensitizing dye include cyanine, merocyanine, complex cyanine, complex merocyanine, holo-polar cyanine, styryl, hemicyanine, oxonol and hemioxonol dyes, as described in JP-A Nos. 63-159841, 60-140335, 63-231437, 63-259651, 63-304242, 63-15245; U.S. Pat. Nos. 4,639,414, 4,740,455, 4,741,966, 4,751,175 and 4,835,096. Usable sensitizing dyes are also described in Research Disclosure (hereinafter, also denoted as RD) 17643, page 23, sect. IV-A (December, 1978), and ibid 18431, page 437, sect. X (August, 1978). It is preferred to use sensitizing dyes exhibiting spectral sensitivity suitable for spectral characteristics of light sources of various laser imagers or scanners. Examples thereof include compounds described in JP-A Nos. 9-34078, 9-54409 and 9-80679.

The infrared sensitizing dyes can be added at any time after preparation of silver halide. For example, the dye can be added to a light sensitive emulsion containing silver halide grains/organic silver salt grains in the form of by dissolution in a solvent or in the form of a fine particle dispersion, so-called solid particle dispersion. Similarly to the heteroatom containing compound adsorptive to silver halide, after adding the dye prior to chemical sensitization and allowing it to be adsorbed onto silver halide grains, chemical sensitization is conducted, thereby preventing dispersion of chemical sensitization center specks and achieving enhanced sensitivity and minimized fogging.

These sensitizing dyes may be used alone or in combination thereof. The combined use of sensitizing dyes is often employed for the purpose of supersensitization. A super-sensitizing compound, such as a dye which does not exhibit spectral sensitization or substance which does not substantially absorb visible light may be incorporated, in combination with a sensitizing dye, into the emulsion containing silver halide grains and organic silver salt grains used in photothermographic imaging materials of the invention.

Useful sensitizing dyes, dye combinations exhibiting super-sensitization and materials exhibiting supersensitization are described in RD17643 (published in December, 1978), IV-J at page 23, JP-B 9-25500 and 43-4933 (herein, the term, JP-B means published Japanese Patent) and JP-A 59-19032, 59-192242 and 5-341432. In the invention, an aromatic heterocyclic mercapto compound represented by the following formula is preferred as a supersensitizer:

Ar—SM

wherein M is a hydrogen atom or an alkali metal atom; Ar is an aromatic ring or condensed aromatic ring containing a nitrogen atom, oxygen atom, sulfur atom, selenium atom or tellurium atom. Such aromatic heterocyclic rings are preferably benzimidazole, naphthoimidazole, benzthiazole, naphthothiazole, benzoxazole, naphthooxazole, benzoselenazole, benzotellurazole, imidazole, oxazole, pyrazole, triazole, triazines, pyrimidine, pyridazine, pyrazine, pyridine, purine, and quinoline. Other aromatic heterocyclic rings may also be included.

A disulfide compound which is capable of forming a mercapto compound when incorporated into a dispersion of an organic silver salt and/or a silver halide grain emulsion is also included in the invention. In particular, a preferred example thereof is a disulfide compound represented by the following formula:

Ar—S—S—Ar

wherein Ar is the same as defined in the mercapto compound represented by the formula described above (represented by Ar—SM).

The aromatic heterocyclic rings described above may be substituted with a halogen atom (e.g., Cl, Br, I), a hydroxy group, an amino group, a carboxy group, an alkyl group (having one or more carbon atoms, and preferably 1 to 4 carbon atoms) or an alkoxy group (having one or more carbon atoms, and preferably 1 to 4 carbon atoms).

In addition to the foregoing supersensitizers, a compound described in U.S. Pat. No. 6,457,710 and a macrocyclic compound can also employed as a supersensitizer in the invention.

The supersensitizer is incorporated into a light-sensitive layer containing organic silver salt and silver halide grains, preferably in an amount of 0.001 to 1.0 mol, and more preferably 0.01 to 0.5 mol per mol of silver.

It is also preferred that a spectral sensitizing dye is allowed to be adsorbed onto the surface of the light-sensitive silver halide grain to bring about spectral sensitization and the resulting spectral sensitization effect be substantially dissipated after being subjected to thermal development. The expression, spectral sensitization effect being substantially dissipated means that the speed of the photothermographic material, achieved by the spectral sensitization decreases, after thermal development, to less than 1.1 times that of the photothermographic material which has not been subjected to spectral sensitization.

The light-sensitive layer or light-insensitive layer may further contains a silver-saving agent. The silver-saving agent used in the invention refers to a compound capable of reducing the silver amount necessary to obtain a prescribed silver density. The action mechanism for the reducing function has been variously supposed and compounds having a function of enhancing covering power of developed silver are preferred. Herein the covering power of developed silver refers to an optical density per unit amount of silver. The silver-saving agent may be incorporated in either a light-sensitive layer or light-insensitive layer, or both of them.

The silver-saving agent is incorporated preferably at 1×10⁻⁵ to 1 mol, and more preferably 1×10⁻⁴ to 5×10⁻¹ mol per mol of silver salt of aliphatic carboxylic acid. Silane compounds are preferably used as a silver-saving agent in this invention. Preferred silane compounds used as a silver-saving agent include an alkoxysilane compound containing at least two primary or secondary amino groups and its salt. The expression, containing at least two primary or secondary amino groups means containing at least two primary amino groups, at least two secondary amino groups or at least one of the respective primary and secondary groups. The salt of the alkoxysilane compound refers to an adduct formed between an inorganic or organic acid capable of forming an onium salt together with an amino group and the alkoxysilane compound.

Binders suitable for photothermographic materials are transparent or translucent and generally colorless, including natural polymers, synthetic polymers or copolymers and film forming mediums. Exemplary examples thereof include gelatin, gum Arabic, polyvinyl alcohol, hydroxyethyl cellulose, cellulose acetate, cellulose acetate butyrate, polyvinyl pyrrolidine, casein, starch, polyacrylic acid, poly(methyl methacrylate), poly(methylmethacrylic acid), polyvinyl chloride, polymethacrylic acid, copoly(styrene-anhydrous maleic acid), copoly(styrene-acrylonitrile), copoly(styrene-butadiene-9, polyvinyl acetals (e.g., polyvinyl formal, polyvinyl butyral), polyesters, polyurethanes, phenoxy resin, polyvinylidene chloride, polyepoxides, polycarbonates, polyvinyl acetate, cellulose esters, and polyamides, these of which may be hydrophilic or hydrophobic.

Of these, polyvinyl acetals are preferred as a binder used for the light sensitive layer, and polyvinyl acetal is specifically preferred binder. Further, for a light insensitive layer such as an over-coating layer or a sublayer, specifically, a protective layer or a back coating layer are preferred cellulose esters exhibiting a relatively high softening temperature, such as triacetyl cellulose and cellulose acetate-butyrate. The foregoing binders may optionally be used in combination.

The binder is used in an amount within the range effective to function as a binder. The effective range can be readily determined by one skilled in the art. As a measure to hold an organic silver salt in the light sensitive layer, the ratio by weight of a binder to an organic silver salt is preferably 15:1 to 1:2, and more preferably 8:1 to 1:1. Thus, the amount of a binder in the light sensitive layer is preferably 1.5 to 6 g/m², and more preferably 1.7 to 5 g/m². The amount of less than 1.0 g/m² results in an increase in unexposed areas, leading to levels unacceptable in practical use.

In one preferred embodiment of the invention, the photothermographic material which has been thermally developed at a temperature of 46 to 200° C. (preferably 70 to 105° C.), exhibits a thermal transition point of not less than 46 to 200° C. The thermal transition point is a value represented in Vicat softening point or a value represented in the ring and ball method, indicating an endothermic peak obtained when measuring the light-sensitive layer separated from the thermally developed photographic material, using a differential scanning calorimeter (or DSC, for example, EXSTAR 6000, available from SEIKO DENSHI KOGYO Co., Ltd.; DSC 220C, SEIKO DENSHI KOGYO Co., Ltd; and DSC-7, available from Perkin Elmer Co.). In general, polymeric compounds have a glass transition point (Tg). It was found by the inventors of the present invention that a large endothermic peak emerged at a temperature lower than the Tg value of binder resin used in the light-sensitive layer. As a result of further study of this thermal transition point temperature, it was newly found that setting the thermal transition point to a temperature of not less than 46° C. and not more than 200° C. prevented softening of the coating layer, thereby preventing abrasion marks.

The glass transition point (Tg) can be determined in accordance with the method described in “Polymer Handbook” at page III-139 to III-179 (1966, published by Wirey and Sons).

In cases where the binder is a copolymer resin, Tg is defined by the following equation:

Tg(copolymer)=v₁Tg₁+v₂Tg₂+. . . +vₙTgₙ

where v₁, v₂, . . . vₙ each represent a weight fraction of respective monomers of the copolymer; Tg₁, Tg₂, . . . Tgₙ each represent a glass transition point, Tg (° C.) of a homopolymer obtained by each of monomers constituting the copolymer. The precision of the Tg calculated by the foregoing equation is within ±5° C.

There can be employed commonly known polymeric compounds as a binder. The glass transition point is preferably 70 to 105° C.; the number average molecular weight is preferably 1,000 to 1,000,000, and more preferably 10,000 to 500,000; and the degree of polymerization is preferably 50 to 1000. Examples thereof include compounds of a polymer or copolymer containing ethylenically unsaturated monomers as a constituting unit, such as vinyl chloride, vinyl acetate, vinyl alcohol, maleic acid, acrylic acid, acrylic acid ester, vinylidene chloride, acrylonitrile, methacrylic acid, methacrylic acid ester, styrene, butadiene, ethylene, vinyl butyral, vinyl acetal and vinyl ether; polyurethane resin, and various kinds of rubber resin. In addition thereto, phenol resin, epoxy resin, polyurethane thermally hardening type resin, urea resin, melamine resin, alkyd resin, formaldehyde resin, silicone resin, epoxy-polyamide resin, and polyester resin are also usable. These resins are detailed in “Plastic Handbook” published by Asakura-shoten. The foregoing polymeric compounds are not specifically limited and there is usable any one having a glass transition point (Tg) of 70 to 105° C., including homopolymers and copolymers.

Examples of polymer containing an ethylenically unsaturated monomer as a constituting unit and its copolymer include acrylic acid alkyl esters, acrylic acid aryl esters, methacrylic acid alkyl esters, methacrylic acid aryl esters, cyanoacrylic acid alkyl esters, and cyanoacrylic acid aryl esters, in which the alkyl or aryl group may be substituted. Examples of substituent groups include methyl, ethyl, n-propyl, isopropyl, n-butyl, isobutyl, sec-butyl, tert-butyl, amyl, hexyl, cyclohexyl, benzyl, chlorobenzyl, octyl, stearyl, sulfopropyl, N-ethyl-phenylethyl, 2-(3-phenylpropyloxy)ethyl, dimethylaminophenoxyethyl, furfuryl, tetrahydrofurfuryl, phenyl, cresyl, naphthyl, 2-hydroxyethyl, 4-hydroxybutyl, triethylene glycol, dipropylene glycol, 2-methoxyethyl, 3-methoxybutyl, 2-aetoxyethyl, 2-acetoxyacetoxyethyl, 2-ethoxyethyl, 2-iso-propoxy, 2-butoxyethyl, 2-(2-methoxy)ethyl, 2-(2-ethoxyethoxy)ethyl, 2-(2-butoxyethoxy)ethyl, 2-diphenylphosphorylethyl, ω-methoxyethylene glycol (addition mole number n=6) allyl, and a dimethylaminoethyl chloride salt. In addition, the following monomers are also usable, including vinyl esters such as vinyl acetate, vinyl propionate, vinyl butyrate, vinyl isobutyrate, vinyl caproate, vinyl chloroacetate, vinyl methoxyacetate, vinyl phenylacetate, vinyl benzoate, and vinyl salicylate; N-substituted acrylamides, N-substituted methacrylamides, acrylamides and methacrylamides, in which N-substituting groups include, for example, methyl, ethyl, propyl, butyl, tert-butyl, cyclohexyl, benzyl, hydroxymethyl, methoxyethyl, dimethylaminoethyl, phenyl, dimethyl, diethyl, β-cyanoethyl, N-(2-acetoacetoxyethyl) and diacetone; olefins such as dicyclopentadiene, ethylene, propylene, 1-butene, 1-pentene, vinyl chloride, vinylidene chloride, isoprene, chloprene, butadiene, and 2,3-dimethylbutadiene; styrenes such as methylstyrene, dimethylstyrene, trimethylstyrene, ethylstyrene, isopropylstyrene, tert-butylstyrene, chloromethylstyrene, methoxystyrene, acetoxystyrene, chlorostyrene, dichlorostyrene, bromostyrene, and methyl vinylbenzoate; vinyl ethers such as methyl vinyl ether, butyl vinyl ether, hexyl vinyl ether, methoxyethyl vinyl ether, and dimethylaminoethyl vinyl ether; N-substituted maleimides, in which N-substituting groups include, for example, methyl, ethyl, propyl, butyl, tert-butyl, cyclohexyl, benzyl, n-dodecyl, phenyl, 2-methylphenyl, 2,6-diethylphenyl and 2-chlorophenyl; and others such as butyl crotonate, hexyl crotonate, dimethylitaconate, dibutyl itaconate, diethyl maleate, dimetyl maleate, dibutyl maleate, diethyl fumarate, dimethyl fumarate, dibutyl fumarate, methyl vinyl ketone, phenyl vinyl ketone, methoxy ethyl ketone, glycidyl acrylate, glycidyl methacrylate, N-vinyl oxazolidone, N-vinyl pyrrolidone, acrylonitrile, methacrylonitrile, methylene malonitrile, and vinylidene chloride.

Of these polymer compounds are preferred methacrylic acid alkyl esters, methacrylic acid aryl esters and styrenes. Specifically, polymer compounds containing an acetal group are preferred, which are superior in miscibility with organic acids produced, preventing softening of the layer.

Polymers exhibiting an equilibrium moisture content of not more than 2 wt % (preferably 0.01 to 1.5 wt %, and more preferably 0.02 to 1 wt %) at a temperature of 25° C. and relative humidity of 60% are usable as binder within the range not vitiating effects of the invention. Definition and determination of the moisture content can be referred, for example, to “Kobunshi-Kogaku Koza 14, Kobunshishikenho” (Polymer Engineering Series Vol. 14, Testing method for Polymer Material, edited by Kobunshi-Gakkai, published by Chijin-Shokan)

The use of a cross-linking agent in such a binder as described above is preferable and improves layer adhesion and lessens unevenness in development, and further inhibits fogging during storage and printing-out of silver after development.

Crosslinking agents usable in the invention include various commonly known crosslinking agents used for photographic materials, such as aldehyde type, epoxy type, vinylsulfon type, sulfonester type, acryloyl type, carbodiimide type crosslinking agents, as described in JP-A 50-96216. In this invention is preferred the use of isocyanate type compounds, silane compounds, epoxy compounds and acid anhydrides.

The crosslinking agent can be incorporated in an amount of 0.001 to 2 mol, preferably 0.005 to 1 mol per mol of silver.

The epoxy compound usable as a crosslinking agent in the invention may be any one containing at least one epoxy group and is not limited with respect to the number of the epoxy group, molecular weight and other parameters. The epoxy group is preferably contained in the form of a glycidyl group through an ether bond or an imino bond in the molecule. The epoxy compound may be any one of a monomer, oligomer and polymer, in which the number of the epoxy group in the molecule is preferably 1 to 10 and more preferably 2 to 4. In cases where the epoxy compound is a polymer, it may be either one of a homopolymer and a copolymer. The number-averaged molecular weight (Mn) thereof is preferably 2,000 to 20,000.

The acid anhydride used in the invention is preferably a compound containing at least an acid anhydride group represented as below:

—CO—O—CO—

The acid anhydride usable in the invention may be any compound containing one or more acid anhydride group, the number of the acid anhydride group, molecular weight or other parameters are not specifically limited.

The acid anhydride compound may be used alone or combination thereof. The amount to be added is not specifically limited, but preferably 1×10⁻⁶ to 1×10⁻¹ mol/m², and more preferably 1×10⁻⁴ to 1×10⁻² mol/m². Chromium alum may also be applied. The acid anhydride compound may be added to any layer of a photosensitive layer, surface protective layer, interlayer, antihalation layer and subbing layer provided on the photosensitive layer-side of the support and may be added to one or plurality of these layers. Further, it may be added to a layer containing the foregoing epoxy compound.

Photothermographic imaging materials of the invention, which form photographic images on thermal development, preferably contains an image tone control agent for controlling silver image color tone, which are contained in the form of a dispersion in a binder matrix. Exemplary preferred toning agents are described in RD17029, U.S. Pat. Nos. 4,123,282, 3,994,732, 3,846,136 and, 4,021,249. Specifically preferred toning agents include phthalazinone, a combination of phthalazine, and phthalic acids or phthalic acid anhydrides.

In this invention, controlling addition of compounds, which directly or indirectly participate in the development process, such as the toning agent described above, a developer, silver halide grains and a silver salt of aliphatic carboxylic acid optimizes the shape of developed silver to bring about preferable image tone. For example, making developed silver in the form of dendride results in bluish tone. The filament form results in slightly yellowish tone. Thus controlling can be achieved considering tendency of the developed silver form. Toning can also be controlled by using couplers described in JP-A No. 11-288057 and European Patent No. 1,134,611A2.

With regard to image tone of the outputted image used for medical diagnosis, it has been supposed that more exact diagnostic observation results can be easily achieved with cold image tone. The cold image tone refers to pure black tone or bluish black tone and the warm image tone refers to a brownish black image exhibiting a warm tone.

The expression regarding to the tone, i.e., “colder tone” or “warmer tone can be determined based on a hue angle, h_{ab} at the minimum density (Dmin) and a density of 1.0. The hue angle, h_{ab} can be represented as h_{ab}=tan⁻¹(b*/a*), using color coordinates a* and b* in L*a*b* color system defined in CIE (19769. As developed silver image tone of the photothermographic material of this invention, the foregoing H_{ab} is preferably within the range of 180°<h_{ab}<270°, more preferably 200°<h_{ab}<270°, and still more preferably 220°<h_{ab}<260°.

In the present invention, a matting agent is preferably incorporated into the surface layer of the photothermographic imaging material (on the light sensitive layer side or even in cases where a light insensitive layer is provided on the opposite side of the support to the light sensitive layer). In order to minimize the image abrasion after thermal development, the matting agent is provided on the surface of a photosensitive material and the matting agent is preferably incorporated in an amount of 1 to 30% by weight of the binder. Materials of the matting agent employed in the invention may be either organic substances or inorganic substances. Examples of the inorganic substances include silica described in Swiss Patent No. 330,158, etc.; glass powder described in French Patent No. 1,296,995, etc.; and carbonates of alkali earth metals or cadmium, zinc, etc. described in U.K. Patent No. 1.173,181, etc. Examples of the organic substances include starch described in U.S. Pat. No. 2,322,037, etc.; starch derivatives described in Belgian Patent No. 625,451, U.K. Patent No. 981,198, etc.; polyvinyl alcohols described in Japanese Patent Publication No. 44-3643, etc.; polystyrenes or polymethacrylates described in Swiss Patent No. 330,158, etc.; polyacrylonitriles described in U.S. Pat. No. 3,079,257, etc.; and polycarbonates described in U.S. Pat. No. 3,022,169.

The matting agent used in the invention preferably has an average particle diameter of 0.5 to 10 μm, and more preferably of 1.0 to 8.0 μm. Furthermore, the variation coefficient of the size distribution is preferably not more than 50%, is more preferably not more than 40%, and is still more preferably not more than 30%. The variation coefficient of the grain size distribution as described herein is a value represented by the following formula:

(standard deviation of particle size/average particle size)×100.

Addition methods of the matting agent include those in which a matting agent is previously dispersed into a coating composition and is then coated, and prior to the completion of drying, a matting agent is sprayed. When plural matting agents are added, both methods may be employed in combination.

To improve electrification properties of photothermographic imaging materials, metal oxides and/or conductive compounds such as conductive polymers may be incorporated into the constituent layer. These compounds may be incorporated into any layer and preferably into a sublayer, a backing layer, interlayer between the light sensitive layer and the sublayer. Conductive compounds described in U.S. Pat. No. 5,244,773, col. 14-20.

Suitable supports used in the photothermographic imaging materials of the invention include various polymeric materials, glass, wool cloth, cotton cloth, paper, and metals (such as aluminum). Flexible sheets or roll-convertible one are preferred. Examples of preferred support used in the invention include plastic resin films such as cellulose acetate film, polyester film, polyethylene terephthalate film, polyethylene naphthalate film, polyamide film, polyimide film, cellulose triacetate film and polycarbonate film, and biaxially stretched polyethylene terephthalate (PET) film is specifically preferred. The support thickness is 50 to 300 μm, and preferably 70 to 180 μm.

The photothermographic material of the invention comprises at least one light-sensitive layer on the support, and further thereon, preferably having a light-insensitive layer. For example, a protective layer is provided on the light-sensitive layer. On the opposite side of the support to the light-sensitive layer, a back coating layer is preferably provided to protect the light-sensitive layer or prevent adhesion. Binders used in the protective layer or back coating layer are preferably selected from polymers which have a glass transition point higher than that of the thermally developable layer and are hard to cause abrasion or deformation, such as cellulose acetate and cellulose acetate-butyrate. To adjust contrast, two or more light-sensitive layers may be provided on one side of the support, or one or more layers may be provided on both sides of the support.

It is preferred to form a filter layer on the same side as or on the opposite side to the light sensitive layer or to allow a dye or pigment to be contained in the light sensitive layer to control the amount of wavelength distribution of light transmitted through the light sensitive layer of photothermographic imaging materials relating to the invention. Commonly known compounds having absorptions in various wavelength regions can used as a dye, in response to spectral sensitivity of the photothermographic material. In cases where the photothermographic imaging material relating to the invention are applied as a image recording material using infrared light is preferred the use of squarilium dye containing a thiopyrylium nucleus (also called as thiopyrylium squarilium dye), squarilium dye containing a pyrylium nucleus (also called as pyrylium squarilium dye), thiopyrylium chroconium dye similar to squarilium dye or pyrylium chroconium. The compound containing a squarilium nucleus is a compound having a 1-cyclobutene-2-hydroxy-4-one in the molecular structure and the compound containing chroconium nucleus is a compound having a 1-cyclopentene-2-hydroxy-4,5-dione in the molecular structure, in which the hydroxy group may be dissociated. Hereinafter, these dyes are collectively called a squarilium dye. Compounds described in JP-A 8-201959 are also preferably usable as a dye.

Materials used in respective constituent layers are dissolved or dispersed in solvents to prepare coating solutions, which were coated on the support and further subjected to a heat treatment to form a photothermographic material. In one preferred embodiment of the invention, plural coating solutions are simultaneously coated to form multi-layers and then subjected to a heating treatment. Thus, coating solutions for respective constituent layers (for example, light-sensitive layer, protective layer) and coating and drying are not repeated for respective layers but plural layers are simultaneously coated and dried to form respective constituent layers. The upper layer is provided before the remaining amount of total solvents in the lower layer reaches 70% or less.

Methods for simultaneously coating plural constituent layers are not specifically limited and commonly known methods, such as a bar coating method, curtain coating method, air-knife method, hopper coating method and extrusion coating method are applicable. Of these, extrusion coating, that is, pre-measuring type coating is preferred. The extrusion coating is suitable for accurate coating or organic solvent coating since no evaporation occur on the slide surface, as in a slide coating system. This coating method is applicable not only to the light-sensitive layer side but also to the case when simultaneously coating a backing layer with the sublayer.

The coating amount of silver is optimally selected in accordance with objectives of photothermographic materials and preferably 0.5 to 1.1.5 g/m², more preferably 0.6 to 1.4 g/m², and still more preferably 1.0 to 1.3 g/m². Of the coating amount of silver described above, the amount of silver relying on silver halide accounts for preferably 2 to 18%, and more preferably 3 to 15%, based on total silver amount. The coating density of silver halide grains of at least 0.01 μm or (circular equivalent diameter) is preferably 1×10¹⁴ to 1×10¹⁸ grains/m², and more preferably 1×10¹⁵ to 1×10¹⁷ grains/m². The coating density of aliphatic carboxylic acid silver salt of at least 0.01 μm (circular equivalent diameter) is preferably 10⁻¹⁶ to 10⁻¹⁴ g, and more preferably 10⁻¹⁷ to 10⁻¹⁵ g per silver halide grain. Coating under the condition falling the ranges described above leads to preferable results in term of the maximum silver image density per a given coating amount of silver (that is, silver covering power) and silver image tone.

The developing conditions for photographic materials are variable, depending on the instruments or apparatuses used, or the applied means and typically accompany heating the imagewise exposed photothermographic imaging material at an optimal high temperature. Latent images formed upon exposure are developed by heating the photothermographic material at an intermediate high temperature (ca. 80 to 200° C., and preferably 100 to 200° C.) over a period of ample time (generally, ca. 1 sec. to ca. 2 min.). Sufficiently high image densities cannot be obtained at a temperature lower than 80° C. and at a temperature higher than 200° C., the binder melts and is transferred onto the rollers, adversely affecting not only images but also transportability or the thermal processor. An oxidation reduction reaction between an organic silver salt (functioning as an oxidant) and a reducing agent is caused upon heating to form silver images. The reaction process proceeds without supplying any processing solution such as water from the exterior.

Heating instruments, apparatuses and means include typical heating means such as a hot plate, hot iron, hot roller or a heat generator employing carbon or white titanium. In the case of a photothermographic imaging material provided with a protective layer, it is preferred to thermally process while bringing the protective layer side into contact with a heating means, in terms of homogeneous-heating, heat efficiency and working property. It is also preferred to conduct thermal processing while transporting, while bringing the protective layer side into contact with a heated roller.

Exposure of photothermographic imaging materials desirably uses a light source suitable to the spectral sensitivity of the photothermographic materials. An infrared-sensitive photothermographic material, for example, is applicable to any light source in the infrared light region but the use of an infrared semiconductor laser (780 nm, 820 nm) is preferred in terms of being relatively high power and transparent to the photothermographic material.

In the invention, exposure is preferably conducted by laser scanning exposure and various methods are applicable to its exposure. One of the preferred embodiments is the use of a laser scanning exposure apparatus, in which scanning laser light is not exposed at an angle substantially vertical to the exposed surface of the photothermographic material. The expression “laser light is not exposed at an angle substantially vertical to the exposed surface” means that laser light is exposed preferably at an angle of 55 to 88°, more preferably 60 to 86°, still more preferably 65 to 84°, and optimally 70 to 82°. When the photothermographic material is scanned with laser light, the beam spot diameter on the surface of the photosensitive material is preferably not more than 200 μm, and more preferably not more than 100 μm. Thus, the smaller spot diameter preferably reduces the angle displaced from verticality of the laser incident angle. The lower limit of the beam spot diameter is 10 μm. The thus configured laser scanning exposure can reduce deterioration in image quality due to reflected light, such as occurrence of interference fringe-like unevenness.

In the second preferred embodiment of the invention, exposure applicable in the invention is conducted preferably using a laser scanning exposure apparatus producing longitudinally multiple scanning laser light, whereby deterioration in image quality such as occurrence of interference fringe-like unevenness is reduced, as compared to scanning laser light with longitudinally single mode. Longitudinal multiplication can be achieved by a technique of employing backing light with composing waves or a technique of high frequency overlapping. The expression “longitudinally multiple” means that the exposure wavelength is not a single wavelength. The exposure wavelength distribution is usually not less than 5 nm and not more than 10 nm. The upper limit of the exposure wavelength distribution is not specifically limited but is usually about 60 nm.

In the first, second and third preferred embodiments of the image recording method of the invention, lasers for scanning exposure used in the invention include, for example, solid-state lasers such as ruby laser, YAG laser, and glass laser; gas lasers such as He—Ne laser, Ar laser, Kr ion laser, CO₂ laser, Co laser, He—Cd laser, N₂ laser and eximer laser; semiconductor lasers such as InGa laser, AlGaAs laser, GaAsP laser, InGaAs laser, InAsP laser, CdSnP₂ laser, and GSb laser; chemical lasers; and dye lasers. Of these, semiconductor lasers of wavelengths of 600 to 1200 nm are preferred in terms of maintenance and the size of the light source. When exposed onto the photothermographic imaging material in the laser imager or laser image-setter, the beam spot diameter on the exposed surface is 5 to 75 μm as a minor axis diameter and 5 to 100 μm as a major axis diameter. The laser scanning speed is set optimally for each photothermographic material, according to its sensitivity at the laser oscillation wavelength and the laser power.

### EXAMPLES

The present invention will be further described based on examples but embodiments of the invention are by no means limited to these examples.

### Example 1

Preparation of Photographic Support

On one side of blue-tinted 175 μm thick polyethylene terephthalate film (PET) exhibiting a density of 0.170 which was previously subjected to a corona discharge treatment at 0.5 kV·A·min/m², sublayer (a) was coated using the following sublayer coating solution A so as to have a dry layer thickness of 0.2 μm. After the other side of the film was also subjected to a corona discharge treatment at 0.5 kV·A·min/m², sublayer (b) was coated thereon using sublayer coating solution B described below so as to have dry layer thickness of 0.1 μm. Thereafter, a heating treatment was conducted at 130° C. for 15 min in a heating treatment type oven having a film transport apparatus provided with plural rolls.

Sublayer Coating Solution A

Copolymer latex solution (30% solids) of 270 g, comprised of n-butyl acrylate/t-butyl acrylate/styrene/2-hydroxyethyl acrylate (30/20/25/25%) was mixed with 0.6 g of compound (UL-1) and 0.5 g of methyl cellulose. Further thereto a dispersion in which 1.3 g of silica particles (SILOID, available from FUJI SYLYSIA Co.) was previously dispersed in 100 g of water by a ultrasonic dispersing machine, Ultrasonic Generator (available from ALEX Corp.) at a frequency of 25 kHz and 600 W for 30 min., was added and finally water was added to make 100 ml to form sub-coating solution A.

Sub-Layer Coating Solution B

The foregoing colloidal tin oxide dispersion of 37.5 g was mixed with 3.7 g of copolymer latex solution (30% solids) comprised of n-butyl acrylate/t-butyl acrylate/styrene/2-hydroxyethyl acrylate (20/30/25/25%), 14.8 g of copolymer latex solution (30% solids) comprised of n-butyl acrylate/styrene/glycidyl methacrylate (40/20/40%), and 0.1 g of surfactant UL-1 (as a coating aid) and water was further added to make 1000 ml to obtain sub-coating solution B.

Synthesis of Colloidal Tin Oxide Dispersion

Stannic chloride hydrate of 65 g was dissolved in 2000 ml of water/ethanol solution. The prepared solution was boiled to obtain co-precipitates. The purified precipitate was taken out by decantation and washed a few times with distilled water. To the water used for washing, aqueous silver nitrate was added to confirm the presence of chloride ions. After confirming no chloride ion, distilled water was further added to the washed precipitate to make the total amount of 2000 ml. After adding 40 ml of 30% ammonia water was added and heated, heating was further continued and concentrated to 470 ml to obtain colloidal tin oxide dispersion.

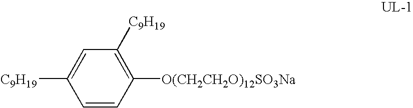

Back Layer-Side Coating

To 830 g of methyl ethyl ketone (also denoted as MEK), 4.2 g of polyester resin (Vitel PE2200B, available from Bostic Corp.) and 84.2 g of cellulose acetate-butyrate (CAB381-20, available from Eastman Chemical Co.) were added and dissolved. To the resulting solution were added 0.30 g of infrared dye 1, 4.5 g of fluorinated surfactant (Surflon KH40, Asahi Glass Co., Ltd.)) and 2.3 g of fluorinated surfactant (Megafac F120K, Dainippon Ink Co., Ltd.) dissolved in 43.2 g of methanol were added with sufficiently stirring until being dissolved. To the resulting solution, 75 g of silica particles (SILOID 64×6000, W. R. Grace Co.) was added to prepare a coating solution for the back-layer side.

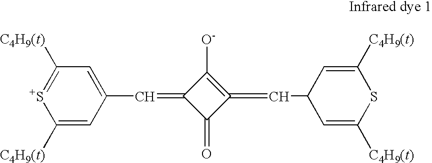

The thus prepared back layer coating solution was coated on the sublayer (b) side of the support so as to form a dry thickness of 3.5 μm, using an extrusion coater and dried at a dry bulb temperature of 100° C. and a dew temperature of 10° C. for 5 min.

Preparation of Light-Sensitive Silver Halide Emulsion 1

| Solution A1 | | |
|---|---|---|
| Phenylcarbamoyl gelatin | 88.3 | g |
| Compound (A) (10% methanol solution) | 10 | ml |
| Potassium bromide | 0.32 | g |
| Water to make | 5429 | ml |
| Solution B1 | | |
| 0.67 mol/l Aqueous silver nitrate solution | 2635 | ml |
| Solution C1 | | |
| Potassium bromide | 51.55 | g |
| Potassium iodide | 1.47 | g |
| Water to make | 660 | ml |
| Solution D1 | | |
| Potassium bromide | 154.9 | g |
| Potassium iodide | 4.41 | g |
| K₃OsCl₆ + K₄[Fe(CN)₆] (each dopant | 50 | ml |
| 2 × 10⁻⁵ mol/l equivalent) | | |
| Water to make | 1982 | ml |
| Solution E1 | | |
| 0.4 mol/l aqueous potassium bromide solution | Amount necessary to | |
| | adjust silver potential | |
| Solution F1 | | |
| Potassium hydroxide | 0.71 | g |
| Water to make | 20 | ml |
| Solution G1 | | |
| Aqueous 56% acetic acid solution | 18 | ml |
| Solution H1 | | |
| Anhydrous sodium carbonate | 1.72 | g |
| Water to make | 151 | ml |

Compound (A): HO(CH₂CH₂O)ₙ—(CH(CH₃)CH₂O)₁₇—CH₂CH₂O)ₘH (m + n = 5 to 7)

Using a stirring mixer described in JP-B Nos. 58-58288 and 58-58289, ¼ of solution B1, the total amount of solution C1 were added to solution A1 by the double jet addition for 4 min 45 sec. to form nucleus grain, while maintaining a temperature of 45° C. and a pAg of 8.09. After 1 min., the total amount of solution F1 was added thereto, while the pAg was adjusted using solution E1. After 6 min, 3/4 of solution B1 and the whole of solution D1 were further added by the double jet addition for 14 min 15 sec., while mainlining a temperature of 45° C. and a pAg of 8.09. After stirring for 5 min., the reaction mixture was lowered to 40° C. and solution G1 was added thereto to coagulate the resulting silver halide emulsion. Remaining 2000 ml of precipitates, the supernatant was removed and after adding 10 lit. water with stirring, the silver halide emulsion was again coagulated. Remaining 1500 ml of precipitates, the supernatant was removed and after adding 10 lit. water with stirring, the silver halide emulsion was again coagulated. Remaining 1500 ml of precipitates, the supernatant was removed and solution H1 was added. The temperature was raised to 60° C. and stirring continued for 120 min. Finally, the pH was adjusted to 5.8 and water was added there to so that the weight per mol of silver was 1161 g, and light-sensitive silver halide emulsion A was thus obtained. It was proved that the resulting emulsion was comprised of monodisperse silver iodobromide cubic grains having an average grain size of 0.050 μm, a coefficient of variation of grain size of 12% and a [100] face ratio of 92%.

Preparation of Light-Sensitive Silver Halide Emulsion 2

Silver halide emulsion 2 was prepared similarly to the foregoing silver halide emulsion 1, except that 5 ml of 0.4% aqueous lead bromide solution was further added to solution Dl. It was proved that the resulting emulsion was comprised of monodisperse silver iodobromide cubic grains having an average grain size of 0.052 μm, a coefficient of variation of grain size of 14% and a [100] face ratio of 94%. Preparation of Light-sensitive Silver Halide Emulsion 3 Silver halide emulsion 3 was prepared similarly to the foregoing silver halide emulsion 1, except that after completion of nucleation, the whole of solution F1 was added, followed by addition of 40 ml of an 5% aqueous solution of 4-hydroxy-6-methyl-1,3,3a,7-tetrazaindene. It was proved that the resulting emulsion was comprised of monodisperse silver iodobromide cubic grains having an average grain size of 0.052 μm, a coefficient of variation of grain size of 14% and a [100] face ratio of 93%.

Preparation of Light-Sensitive Silver Halide Emulsion 4

Silver halide emulsion 4 was prepared similarly to the foregoing silver halide emulsion 1, except that 40 ml of a solution of K₃₀OsCl₆ and K₄[Fe(CN)₆, as dopants. It was proved that the resulting emulsion was comprised of monodisperse silver iodobromide cubic grains having an average grain size of 0.051 μm, a coefficient of variation of grain size of 13% and a [100] face ratio of 91%.

Preparation of Light-Sensitive Silver Halide Emulsion 5

Silver halide emulsion 5 was prepared similarly to the foregoing silver halide emulsion 1, except that K₃₀OsCl₆ and K₄[Fe(CN)₆, were not used at all. It was proved that the resulting emulsion was comprised of monodisperse silver iodobromide cubic grains having an average grain size of 0.052 μm, a coefficient of variation of grain size of 14% and a [100] face ratio of 93%.

Preparation of Powdery Silver Aliphatic Carboxylate A

Behenic acid of 130.8 g, arachidic acid of 67.7 g, stearic acid of 43.6 g and palmitic acid of 2.3 g were dissolved in 4720 ml of water at 80° C. Then, 540.2 ml of aqueous 1.5 mol/l NaOH was added, and after further adding 6.9 ml of concentrated nitric acid, the mixture was cooled to 55° C. to obtain a fatty acid sodium salt solution. To the thus obtained fatty acid sodium salt solution, after adding 347 ml of t-butyl alcohol, 45.3 g (0.039 mol of silver equivalent) of light-sensitive silver halide emulsion1 obtained above and 450 ml of water were added and stirred for 5 min., while being maintained at 55° C. Subsequently, 702.6 ml of 1M aqueous silver nitrate solution was added in 2 min. and stirring continued further for 20 min., then, the reaction mixture was filtered to remove aqueous soluble salts. Thereafter, washing with deionized water and filtration were repeated until the filtrate reached a conductivity of 50 μS/cm. Using a flush jet dryer (produced by Seishin Kigyo Co., Ltd.), the thus obtained cake-like organic silver salt was dried under an atmosphere of nitrogen gas, according to the operation condition of a hot air temperature at the inlet of the dryer until reached a moisture content of 0.1% to obtain dried powdery organic silver salt A. The moisture content was measured by an infrared ray aquameter.

Preparation of Premix A

In 1457 g MEK was dissolved 14.57 g of polyvinyl butyral resin (B-79, SOLCIA Co.) and further thereto, 500 g of the foregoing powdery organic silver salt A was gradually added to obtain preliminarily dispersed mixture, premix A, while stirring by a dissolver type homogenizer (DISPERMAT Type CA-40M, available from VMA-GETZMANN).

Preparation of Light-Sensitive Emulsion A

Thereafter, using a pump, the foregoing premix A was transferred to a media type dispersion machine (DISPERMAT Type SL-C12 EX, available from VMA-GETZMANN), which was packed 1 mm Zirconia beads (TORAY-SELAM, available from Toray Co. Ltd.) by 80%, and dispersed at a circumferential speed of 8 m/s and for 1.5 min. of a retention time with a mill to obtain light-sensitive emulsion A.

Preparation of Stabilizer Solution

In 4.97 g methanol were dissolved 1.0 g of Stabilizer-1 and 0.31 g of potassium acetate to obtain stabilizer solution.

Preparation of Infrared Sensitizing Dye Solution A

In 31.3 ml MEK were dissolved 19.2 mg of infrared sensitizing dye-1, 1.488 g of 2-chlorobenzoic acid, 2.779 g of Stabilizer-2 and 365 mg of 5-methyl-2-mercaptobenzimidazole in a dark room to obtain an infrared sensitizing dye solution A.

Preparation of Additive Solution (a)

In 110 g MEK were dissolved 27.98 g of reducing agent 1, 0.7 g of compound 1-1 of formula 1-1, 1.54 g of 4-methylphthalic acid and 0.48 g of the infrared dye 1 to obtain additive solution (a).

Preparation of Additive Solution (b)

Antifoggants-2, of 3.56 g were dissolved in 40.9 g MEK to obtain additive solution (b).

Preparation of Light-Sensitive Layer Coating Solution A

Under inert gas atmosphere (97% nitrogen), 50 g of the light-sensitive emulsion A and 15.11 g of MEK were maintained at 21° C. with stirring, and 390 μl of antifoggant-1 (10% methanol solution) was added and stirred for 1 hr. Further thereto, 494 μl of calcium bromide (10% methanol solution) was added and after stirring for 20 min. Subsequently, 1.32 g of infrared sensitizing dye solution A was added and stirred for 1 hr. Then, the mixture was cooled to 13° C. and stirred for 30 min. Further thereto, 13.31 g of polymer P-9, as binder resin was added and stirred for 30 min, while maintaining the temperature at 13° C., and 1.084 g of tetrachlorophthalic acid (9.4% MEK solution) and stirred for 15 min. Then, 12.43 g of additive solution (a), 1.6 ml of 10% MEK solution of Desmodur N3300 (aliphatic isocyanate, product by Movey Co., 10% MEK solution)) and 4.27 g of additive solution (b) were successively added with stirring to obtain coating solution A of the light-sensitive layer.

Preparation of Surface Protective Layer Coating Solution

To 865 g of MEK, 96 g of cellulose acetate-butyrate (CAB171-15, available from Eastman Chemical Co.), 4.5 g of polymethyl methacrylate (Paraloid A-21, available from Rohm & Haas Corp.), 1.0 g of benzotriazole, 1.5 g of a vinylsulfone compound (VSC) and 1.0 g of a fluorinated surfactant (EFTOP EF-105, available from JEMCO Co.) were added. Subsequently, 30 g of the foregoing matting agent dispersion was added thereto to prepare a surface protective layer coating solution.

Preparation of Matting Agent Dispersion

To 42.5 g of MEK, 7.5 g of cellulose acetate-butyrate (CAB171-15, available from Eastman Chemical Co.) was added with stirring. Further thereto, 5 g of Silica particles (SYLOID 320, available from FUJI SYLYSIA Co.) was added and stirred for 30 min. using a dissolver type homogenizer at 8,000 rpm to obtain a matting agent dispersion.

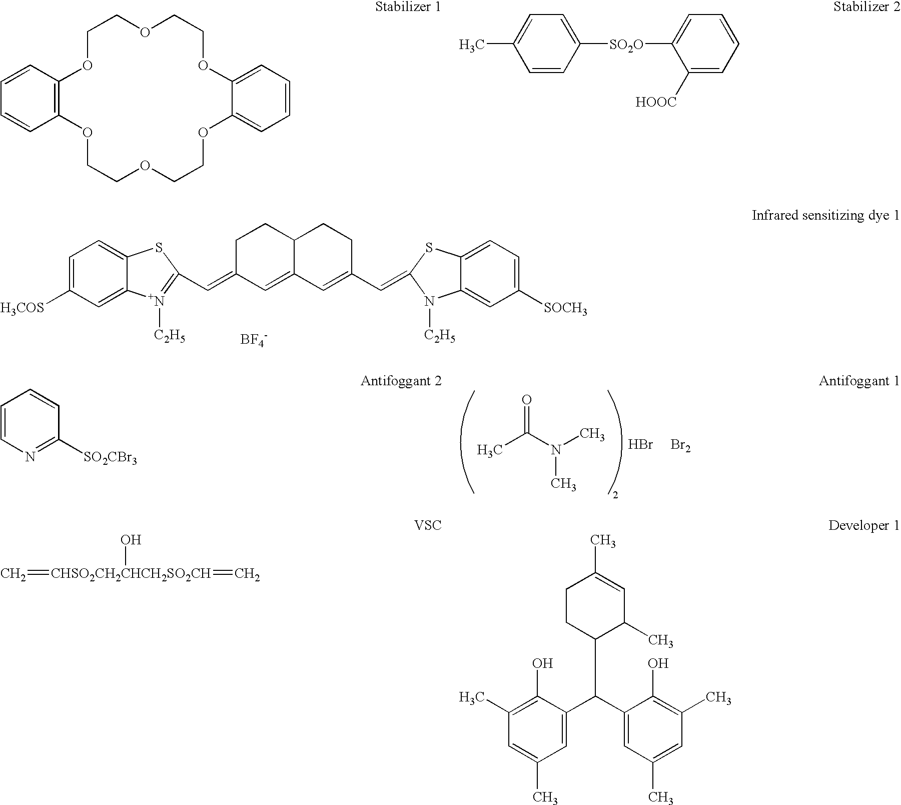

Preparation of Photothermographic Material Preparation of Sample 101

The foregoing light-sensitive layer coating solution A and surface protective layer coating solution were simultaneously coated on the sublayer (b) of the support using a commonly known extrusion type coater to prepare sample 101. Coating was conducted so as to form a light-sensitive layer having a silver coverage of 1.5 g/m² and a 2.5 μm thick surface protective layer. Drying was carried out for 10 min with hot air of a dry bulb temperature of 75° C. and a dew point of 10° C. Sample No. 101 was thus obtained.

Preparation of Samples 102 through 116

Samples 102 through 116 were prepared similarly to sample 101, provided that the kind of a light-sensitive silver halide emulsion contained in the light-sensitive layer coating solution A and chemical sensitization of the silver halide emulsion were each varied, and the proportion of silver behenate of aliphatic carboxylic acid silver salts were varied to change a melting point, as shown in Table 1.

The foregoing variations were conducted according to the following manner.

1. To vary the melting point of aliphatic carboxylic acid, the content of silver behenate was changed, while relative content ratio of silver arachidate, silver stearate and silver palmitate being kept constant.

2. Chemical sensitization was carried out at 55° C. for 120 min. with stirring, by adding 240 ml of sulfur sensitizer S-5 (0.5% methanol solution) and gold sensitizer Au-5 in an amount of 1/20 molar equivalent to the sulfur sensitizer to the respective silver halide emulsions which were each made up with water to 1161 g per mol of silver.

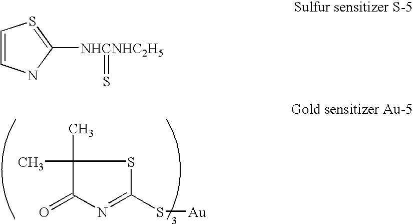

Exposure and Processing

Samples each were subjected to laser scanning exposure from the emulsion side using an exposure apparatus having a light source of 800 nm and 820 nm semiconductor laser of longitudinal multi-mode, which was made by means of high frequency overlapping. In this case, exposure was conducted at an angle of 75°, between the exposed surface and exposing laser light and as a result, images with superior sharpness were unexpectedly obtained, as compared to exposure at an angle of 90°. Subsequently, using an automatic processor provided with a heated drum, exposed samples were subjected to thermal development at a temperature of 110° C. for 15 sec., while bringing the protective layer surface of the photothermographic material into contact with the drum surface. Exposure and thermal development were conducted in an atmosphere at 23° C. and 50% RH. Obtained images were evaluated based on densitometry.

Sensitivity and Fog Density

Processed samples were each subjected to densitometry using a densitometer to prepare a characteristic curve of abscissa-exposure and ordinate-density. Sensitivity (designated S) was defined as the reciprocal of exposure giving a density of 1.0 above a density in the unexposed area (fog density, designated Fog). The sensitivity was represented by a relative value, based on the sensitivity of sample 105 being 100. The minimum density (or fog density, designated Fog) and the maximum density were also determined. Determination of Sensitivity Ratio (S_{B}/S_{A})

Each sample was subjected to a heat treatment at 110° C. for 15 sec., exposed to white light (4874K) for 30 sec. through an optical wedge, and then developed at 110° C. for a period of 15 sec. The sensitivity of the thus processed sample was determined (designated S_{B}). The sensitivity (designated S_{A}) was determined similarly to the foregoing S_{B}, provided that the heat treatment prior to exposure was removed. The sensitivity ratio, S_{B}/S_{A} for each sample was thus determined.

Evaluation of Storage Stability

After aged under the following condition A or B for 10 days, each aged sample was exposed and developed similarly to the determination of S_{A} to determine the minimum density. Thus, minimum densities and hue angles were measured for the respective aging conditions A and B, and variation in minimum density (also designated as Dₘᵢₙ¹) and variation in hue angle (also designated as h_{ab}¹), as a measure of storage stability, were determined in accordance with the following equations (1) and (2):

Condition A: 25° C. and 55% RH

Condition B: 40° C. and 80% RH

Variation in minimum density (Dₘᵢₙ¹)=(minimum density at condition B/minimum density at condition A)×100 Equation (1)

Variation in hue angle (h_{ab}¹)=|hue angle at condition B minus hue angle at condition A|/| hue angle at condition A×100. Equation (2)

A Dₘᵢₙ¹ value closer to 100 or a less h_{ab}¹ value indicates superior storage stability.

Determination of Hue Angle (h_{ab})

The hue angle (h_{ab}) was determined in the manner that processed samples were measured with respect to areas corresponding to the minimum density and an optical density of 1.0 using a calorimetric light source, D65 of CIE and a spectral colormeter CM-508d (available from Minolta Co., Ltd.) at a visual field of 2°.

Evaluation of Image Lasting Quality

Samples which were thermally processed in the same manner as in the determination of sensitivity S_{A} were continuously exposed to light in an atmosphere at 45° C. and 55% RH for 3 days, in which commercially available white fluorescent lamp was arranged so as to exhibit an illumination intensity of 900 lux on the surface of each sample. Thereafter, exposed and unexposed samples were measured for the minimum density and hue angle, and variation in minimum density (designated as Dₘᵢₙ²) and variation in hue angle (designated as h_{ab}²) were determined in accordance with the following equations (3) and (4):

Variation in minimum density (Dₘᵢₙ²)=(D₂−D₁)/D₁×100 (%) Equation (3)

Variation in hue angle (h_{ab}²)=|hue angle after exposure to fluorescent light minus hue angle before exposure to fluorescent light|/|hue angle before exposure to fluorescent light|×100 Equation (4)

wherein D₁ represents the minimum density of a sample unexposed to fluorescent lamp light and D₂ represents the minimum density of a sample exposed to fluorescent lamp light.

A Dₘᵢₙ² value closer to 100 or a less h_{ab}² value indicates superior image lasting quality.

Results are shown in Table 1.

TABLE 1

| | | | | | Photographic | | | Storage | | Image Lasting | | |
|---|---|---|---|---|---|---|---|---|---|---|---|---|
| | Silver Aliphatic Carboxylate | | | | Characteristic | | | Stability | | Quality | | |
| | | Silver | | | | | | | | | | |
| Sam- | Com- | Halide | Melting | Behenic | | | | | | | | |
| ple | pound | Emulsion | Point *³ | Acid | | | S_{B}/ | | | | | Re- |
| No. | (1) *¹ | (*2) | (° C.) | (mol %) | Fog | S | S_{A} | Dₘᵢₙ¹ | h_{ab}¹ | Dₘᵢₙ² | h_{ab}² | mark |
| 101 | 1-1 | 1 (No) | 58 | 54 | 0.194 | 215 | 0.17 | 116 | 10 | 112 | 10 | Inv. |
| 102 | 1-1 | 2 (No) | 58 | 54 | 0.179 | 220 | 0.14 | 112 | 8 | 107 | 8 | Inv. |
| 103 | 1-1 | 3 (No) | 58 | 54 | 0.189 | 215 | 0.12 | 112 | 7 | 112 | 8 | Inv. |
| 104 | 1-1 | 4 (No) | 58 | 54 | 0.174 | 231 | 0.10 | 112 | 6 | 110 | 7 | Inv. |
| 105 | 1-1 | 5 (No) | 58 | 54 | 0.225 | 100 | 0.28 | 130 | 17 | 150 | 23 | Comp. |
| 106 | 1-1 | 1 (Yes) | 58 | 54 | 0.204 | 462 | 0.14 | 121 | 12 | 123 | 10 | Inv. |
| 107 | 1-1 | 2 (Yes) | 58 | 54 | 0.189 | 468 | 0.12 | 121 | 9 | 118 | 10 | Inv. |
| 108 | 1-1 | 3 (Yes) | 58 | 54 | 0.189 | 468 | 0.10 | 116 | 8 | 118 | 9 | Inv. |
| 109 | 1-1 | 4 (Yes) | 58 | 54 | 0.184 | 473 | 0.08 | 116 | 7 | 116 | 8 | Inv. |
| 110 | 1-1 | 5 (Yes) | 58 | 54 | 0.238 | 170 | 0.50 | 135 | 20 | 140 | 26 | Comp. |
| 111 | 1-1 | 3 (Yes) | 62 | 65 | 0.185 | 468 | 0.10 | 111 | 8 | 114 | 8 | Inv. |
| 112 | 1-1 | 3 (Yes) | 70 | 85 | 0.178 | 468 | 0.10 | 108 | 7 | 110 | 7 | Inv. |
| 113 | 1-1 | 3 (Yes) | 75 | 95 | 0.175 | 460 | 0.10 | 105 | 6 | 108 | 7 | Inv. |
| 114 | — | 3 (No) | 58 | 54 | 0.196 | 194 | 0.30 | 123 | 15 | 130 | 16 | Comp. |
| 115 | — | 3 (Yes) | 58 | 54 | 0.202 | 398 | 0.25 | 129 | 17 | 136 | 19 | Comp. |
| 116 | — | 3 (Yes) | 75 | 95 | 0.195 | 387 | 0.25 | 122 | 16 | 131 | 18 | Comp. |

*¹ Compound of formula (1)
*2 Chemical sensitization
*³ Melting point of aliphatic carboxylic acid

As apparent from Table 1, photothermographic material samples according to this invention exhibited enhanced sensitivity, minimized fog density and superior storage stability and image lasting quality, compared to comparative samples. Although is not shown in Table 1, it was proved that the inventive samples exhibited a hue angle of more than 200° and less than 265°, resulting in cold-tone images suitable for medical diagnosis.

### Example 2

Preparation of Silver Halide Emulsion 6

Light-sensitive silver halide emulsion 6 (designated as Em-6) was prepared similarly to light-sensitive silver halide emulsion 5 (designated, Em-S) in Example 1, provided that in the simultaneous addition of 3/4 of solution B1 and the whole of solution D1 at a pAg of 8.09 for 14 min 15 sec, the temperature was changed to 27° C. It was proved that the resulting emulsion was comprised of monodisperse silver iodobromide cubic grains having an average grain size of 0.031 μm, a coefficient of variation of grain size of 14% and a [100] face ratio of 90%.

Preparation of Silver Halide Emulsion 7

Light-sensitive silver halide emulsion 7 (designated, Em-7) was prepared similarly to the foregoing silver halide emulsion 6, provided that in the simultaneous addition of 3/4 of solution B1 and the whole of solution D1 at a pAg of 8.09 for 14 min 15 sec, the temperature was changed to 60° C. It was proved that the resulting emulsion was comprised of monodisperse silver iodobromide cubic grains having an average grain size of 0.081 μm, a coefficient of variation of grain size of 14% and a [100] face ratio of 92%.

Preparation of Silver Halide Emulsion 8

Light-sensitive silver halide emulsion 8 (designated, Em-8) was prepared similarly to light-sensitive silver halide emulsion 3 (designated, Em-3) in Example 1, provided that in the simultaneous addition of 3/4 of solution B1 and the whole of solution D1 at a pAg of 8.09 for 14 min 15 sec, the temperature was changed to 27° C. It was proved that the resulting emulsion was comprised of monodisperse silver iodobromide cubic grains having an average grain size of 0.030 μm, a coefficient of variation of grain size of 14% and a [100] face ratio of 91%.

Preparation of Silver Halide Emulsion 9

Light-sensitive silver halide emulsion 9 (designated, Em-9) was prepared similarly to the foregoing silver halide emulsion 8, provided that in the simultaneous addition of 3/4 of solution B1 and the whole of solution D1 at a pAg of 8.09 for 14 min 15 sec, the temperature was changed to 60° C. It was proved that the resulting emulsion was comprised of monodisperse silver iodobromide cubic grains having an average grain size of 0.080 μm, a coefficient of variation of grain size of 14% and a [100] face ratio of 91%.

Preparation of Silver Halide Emulsion 10

Light-sensitive silver halide emulsion 10 (designated, Em-10) was prepared similarly to the foregoing silver halide emulsion 9, provided that in the simultaneous addition of 3/4 of solution B1 and the whole of solution D1 at a pAg of 8.09 for 14 min 15 sec, the temperature was changed to 85° C. It was proved that the resulting emulsion was comprised of monodisperse silver iodobromide cubic grains having an average grain size of 0.123 μm, a coefficient of variation of grain size of 14% and a [100] face ratio of 91%.

The thus prepared light-sensitive silver halide emulsions each were chemically sensitized using chemical sensitizers used in Example 1, provided that amounts of chemical sensitizers were varied in inverse proportion to an average grain size of the respective silver halide emulsions, on the basis of silver halide emulsion 3 or 5.

Preparation of Powdery Silver Aliphatic Carboxylate a to h

Silver salts of aliphatic carboxylic acids (silver carboxylates a to h) were each prepared similarly to powdery silver aliphatic carboxylate A in Example 1, provided that the kind and mixing ratio of silver halide emulsion, and the melting point of carboxylic acid were varied, as shown in Table 2. The melting point was controlled similarly to Example 1.

TABLE 2

| Powdery | | | | | | | | |
|---|---|---|---|---|---|---|---|---|
| Silver | Mixing Ratio of Silver Halide Emulsion (wt %, based on Ag) | | | | | | | |
| Carboxylate | Em-6 | Em-5 | Em-7 | Em-8 | Em-3 | Em-9 | Em-10 | |
| (° C.*²) | (0.031*¹) | (0.052*¹) | (0.081*¹) | (0.030*¹) | (0.052*¹) | (0.080*¹) | (0.120*¹) | Dopant |
| a (58) | 15 | 70 | 15 | — | — | — | — | No |
| b (58) | 30 | 40 | 30 | — | — | — | — | No |
| c (58) | — | — | — | 15 | 70 | 15 | — | Yes |
| d (58) | — | — | — | 30 | 40 | 30 | — | Yes |
| e (58) | — | — | — | 15 | 70 | — | 15 | Yes |
| f (58) | — | — | — | 30 | 70 | — | — | Yes |
| g (58) | — | — | — | — | 70 | 30 | — | Yes |
| h (75) | — | — | — | 15 | 70 | 15 | — | Yes |

*¹Average grain size (μm)
*²melting point of aliphatic carboxylic acid

Preparation of Sample 201 to 208

Photothermographic material samples 201 through 208 were each prepared similarly to sample 108 in Example 1, except that powdery silver carboxylate shown in Table 3 was used. In each sample, binder used in the light-sensitive layer coating solution was optimally adjusted so that the light-sensitive layer exhibited a thermal transition temperature of ca. 55° C.

Exposure, Processing and Evaluation

Similarly to Example 1, samples were subjected to exposure and thermal development, and evaluated with respect to fog density, sensitivity, S_{B}/S_{A}, storage stability and image lasting quality. Sensitivity was represented by a relative value, based on the sensitivity of sample 201 being 100.

Thermal Process Stability

Samples were further evaluated with respect to thermal process stability, according to the following manner. Exposed samples were developed at a temperature of 108° C., 110° C. and 112° C. and a slope of the line connecting points corresponding the density of the minimum density plus 0.5 and the density of the minimum density plus 2.5. Variation in slope, which was determined according to the following equation, was evaluated as a measure of thermal process stability, The less value indicates superior thermal stability.

Variation in slope=(maximum slope)/(minimum slope)

Results are shown in Table 3.

TABLE 3

| | | Photographic | | | Storage | | Image | | Thermal | |
|---|---|---|---|---|---|---|---|---|---|---|
| Sample | Silver | Characteristic | | | Stability | | Fastness | | Process | |
| No. | Carboxylate | Fog | S | S_{B}/S_{A} | Dₘᵢₙ¹ | h_{ab}¹ | Dₘᵢₙ² | h_{ab}² | Stability | Remark |
| 201 | a | 0.24 | 100 | 0.54 | 135 | 20 | 140 | 26 | 11 | Comp. |
| 202 | b | 0.25 | 107 | 0.51 | 145 | 25 | 151 | 29 | 16 | Comp. |
| 203 | c | 0.19 | 275 | 0.11 | 116 | 8 | 118 | 9 | 5 | Inv. |
| 204 | d | 0.20 | 289 | 0.17 | 123 | 11 | 124 | 12 | 8 | Inv. |
| 205 | e | 0.19 | 295 | 0.13 | 119 | 10 | 121 | 11 | 7 | Inv. |
| 206 | f | 0.19 | 266 | 0.12 | 110 | 7 | 113 | 8 | 4 | Inv. |
| 207 | g | 0.19 | 284 | 0.13 | 117 | 9 | 120 | 10 | 6 | Inv. |
| 208 | h | 0.18 | 271 | 0.10 | 105 | 6 | 108 | 7 | 3 | Inv. |

As apparent from Table 3, photothermographic material samples according to this invention exhibited enhanced sensitivity, minimized fog density and superior storage stability and image lasting quality, compared to comparative samples. Although is not shown in Table 3, it was proved that the inventive samples exhibited a hue angle of more than 200° and less than 265°, resulting in cold-tone images suitable for medical diagnosis.

What is claimed is:

1. A photothermographic material comprising on a support a light-sensitive layer containing a light-insensitive silver salt of an aliphatic carboxylic acid and light-sensitive silver halide grains, a reducing agent for silver ions and a binder, wherein the photothermographic material further comprises a compound represented by the following formula (1), and the photothermographic material meets the following requirement:
S_{B}/S_{A}<0.2
wherein S_{A} represents a sensitivity obtained when exposed and thermally developed, and S_{B} represents a sensitivity obtained when subjected to a heat treatment at 110° C. for 15 sec., then, exposed and thermally developed; 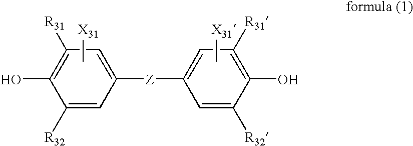
wherein Z is —S— or —C(R₃₃) (R₃₃′)—, in which R₃₃ and R₃₃′ are each a hydrogen atom or a substituent; R₃₁, R₃₂, R₃₁′ and R₃₂′ are each a substituent; X₃₁ and X₃₁′ are each a hydrogen atom or a substituent.

2. The photothermographic material of claim 1, wherein in formula (1), R₃₃ and R₃₃′ are each a hydrogen atom, or an alkyl or cycloalkyl group.

3. The photothermographic material of claim 1, wherein in formula (1), at least one of R₃₃ and R₃₃′ is a hydrogen atom and the other one is a hydrogen atom, or an alkyl or cycloalkyl group.

4. The photothermographic material of claim 1, wherein in formula (1), R₃₁, R₃₂, R₃₁′ and R₃₂′ are each an alkyl group, alkenyl group, alkynyl group, cycloalkyl group, cycloalkenyl group, aryl group or heterocyclic group.

5. The photothermographic material of claim 1, wherein the silver halide grains each internally contain an electron trapping dopant.

6. The photothermographic material of claim 5, wherein the electron trapping dopant is contained in an amount of 1×10⁻⁸ to 1×10⁻¹ mol per mol of silver.

7. The photothermographic material of claim 5, wherein the electron trapping dopant is selected from the group consisting of metal ions except for silver ion and their salts or complexes, chalcogens, chalcogen- or nitrogen-containing compounds, and rare earth ions and their complexes.

8. The photothermographic material of claim 7, wherein the electron trapping dopant is selected from the group consisting of lead ion, bismuth ion, gold ion and their salts.

9. The photothermographic material of claim 7, wherein the electron trapping dopant is a complex of a transition metal ion selected from the group consisting of W, Fe, Co, Ni, Cu, Ru, Rh, Pd, Os, Ir and Pt.

10. The photothermographic material of claim 1, wherein the silver halide grains are silver bromide or silver iodobromide.

11. The photothermographic material of claim 1, wherein grains having a grain size of 0.04 to 0.07 μm account for at least 50% by weight of the silver halide gains, based on silver.

12. The photothermographic material of claim 1, wherein the aliphatic carboxylic acid exhibits a melting point of 70 to 90° C.

13. The photothermographic material of claim 1, wherein the silver salt of an aliphatic carboxylic acid is comprised of grains having an average equivalent circular diameter of 0.05 to 0.8 μm and an average thickness of 0.005 to 0.07 μm.
